(19) United States
(12) Patent Application Publication
(10) Pub. No.: US 2025/0392134 A1
(43) Pub. Date: Dec. 25, 2025

(54) TECHNIQUES FOR IES CONTROLS FOR TARGET RESOURCE PRODUCTION

(71) Applicant: NuScale Power, LLC, Corvallis, OR (US)

(72) Inventors: Robert Aldridge, Corvallis, OR (US); Olin Calvin, Corvallis, OR (US); Brandon Pearse, Corvallis, OR (US); Brock Cloutier, Corvallis, OR (US); Jacob Rammer, Corvallis, OR (US); Ryan Flamand, Corvallis, OR (US); Daniel Bryant, Columbia, MD (US); Joseph Lanzetta, Columbia, MD (US); Kyle Cummins, Corvallis, OR (US)

(21) Appl. No.: 18/749,414

(22) Filed: Jun. 20, 2024

(51) Int. Cl. H02J 3/38; F01K 15/00; H02J 13/00

(52) U.S. Cl. CPC H02J 3/38; F01K 15/00; H02J 13/00002

(57) ABSTRACT

Described herein are techniques for managing resource production within an integrated energy system. Such techniques may comprise receiving an indication of a resource production target associated with a set of resource production components and determining, based on the resource production target, a set of configuration settings associated with the set of resource production components. The techniques may further comprise determining, based on the set of configuration settings associated with the set of resource production components, an amount of steam and power to achieve the resource production target and providing instructions to one or more control mechanisms of a power plant system to cause the power production plant to provide the amount of steam and power to the set of resource production components.

### BACKGROUND

The energy production landscape has evolved rapidly in recent years, with a growing emphasis on decarbonization, sustainability, and resilience, driving the adoption of cleaner and more efficient forms of power production. While fossil fuels continue to play a significant role in global energy supply, there is a clear trend toward increased deployment of renewable energy, coupled with advancements in energy storage, grid modernization, and energy efficiency measures, to address the challenges of climate change and energy transition.

An Integrated Energy System (IES) incorporates various energy conversion technologies, such as power plants, cogeneration (combined heat and power) systems, and distributed generation units (such as solar panels and wind turbines). These technologies convert primary energy sources into usable forms of energy, such as electricity, heat, and mechanical power that can be used as secondary energy sources. IESs leverage a diverse range of energy resources, including renewable energy sources (such as solar, wind, nuclear, and hydroelectric power), conventional fuels (such as natural gas and coal), and emerging technologies (such as hydrogen and biofuels). By combining multiple energy sources, these systems can enhance energy security and resilience.

Energy storage plays a crucial role in IESs by enabling the efficient management of energy supply and demand, as well as the integration of intermittent renewable energy sources. Various storage technologies, including batteries, pumped hydro storage, thermal energy storage, and hydrogen storage, can be deployed to store surplus energy during periods of low demand periods, which can then be used to supply additional energy during peak demand periods or when a primary energy source is unavailable.

Because of the drive toward cleaner and more efficient forms of power production, nuclear power will be increasingly important in the coming years. Nuclear power plants provide reliable baseload power and produce minimal greenhouse gas emissions during operation, making them attractive for countries that are seeking to reduce carbon emissions and enhance energy security. For example, nuclear power plants produce electricity without emitting greenhouse gases such as carbon dioxide (CO₂) during operation.

In operation, nuclear power plants use nuclear fission to generate heat, which is then used to produce steam to turn turbines and generate electricity. This process can result in the production of both electrical power and steam. Both of these products are essential to operate may types of plants, factories, and refineries that produce other types of products such as chemicals. Steam can be especially useful in a wide range of industries that use heat sources. Steam is used as a heat source for process fluid heat exchangers, reboilers, reactors, combustion air preheaters, and other types of heat transfer equipment.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an integrated energy system that includes a power plant system in accordance with at least some embodiments.

FIG. 2 provides a schematic view of a resource production plant operating in tandem with a power plant in accordance with various embodiments as disclosed herein.

FIG. 3 provides a schematic view of an IES control system in communication with a control room of a power plant system to implement techniques for management of resource production in accordance with embodiments.

FIG. 4 depicts a block diagram illustrating an example of a process for producing hydrogen gas using excess steam and power generated by a power plant in accordance with at least some embodiments.

FIG. 5 depicts a block diagram illustrating a process for spinning up multiple resource modules for resource production based on a difference between a current power production and a current power demand.

FIG. 6 depicts a component diagram of an example IES control system to be implemented in order to generate configuration settings for resource production in accordance with at least some embodiments.

FIG. 7 depicts a block diagram illustrating an architecture for managing a number of resource production process components via an IES control system in accordance with at least some embodiments.

FIG. 8 depicts a flow diagram illustrating a process for managing various process components operating within a resource production process in accordance with some embodiments.

FIG. 9 depicts a block diagram illustrating an exemplary process for allocating steam and power to different resource production processes in accordance with at least some embodiments.

FIG. 10 depicts a flow diagram illustrating a first exemplary process for managing resource production operations in accordance with at least some embodiments.

FIG. 11 depicts a flow diagram illustrating a second exemplary process for managing resource production operations in accordance with at least some embodiments.

FIG. 12 is a schematic view of a nuclear power plant system including multiple nuclear reactors in accordance with embodiments of the present technology.

FIG. 13 is a partially schematic, partially cross-sectional view of a nuclear reactor system configured in accordance with embodiments of the present technology.

FIG. 14 is a partially schematic, partially cross-sectional view of a nuclear reactor system configured in accordance with additional embodiments of the present technology.

### DETAILED DESCRIPTION

In embodiments, the disclosure is directed to techniques that may be performed in relation to Integrated Energy Systems (IESs) that include a power plant (e.g., a primary power plant) that is integrated with one or more resource production plants. Such an IES may be capable of producing a resource (e.g., chemical products such as hydrogen, methanol, ammonia) using excess power/steam from the power plant. The IES may be in communication with a secondary power plant that is configured to consume the generated resource from the resource production plants in order to produce additional power, such as when the primary power plant is not producing sufficient power to meet the demands on a power grid. It should be noted that using excess power to produce resources can have multiple advantages over simply storing that excess power (e.g., in a battery) for later use. For example, such resources may be consumed at a later date or in another location to provide an alternative power source. In some cases, the produced resources are more easily transportable, allowing the resources to be used to provide power to areas/regions that may not have access to a power grid.

This disclosure is directed to a IES control system that is configured to operatively control one or more nuclear reactor modules of a nuclear power plant that interfaces with a resource production plant. The resource production plant, in turn, generates resources that can be stored and/or later consumed to generate additional power. In one example, one or more components of the resource production plant may consume steam (and/or power) generated by the power plant in order to produce the resources such a hydrogen. Resource production is performed using allocated excess power and/or steam (sometimes referred to as “byproduct” steam) produced by a power plant. In some cases, resource production units may be spun up during times at which power being consumed on a power grid is less than the power currently being generated by a power plant in order to consume the excess power/steam being produced by that power plant.

During operation, the IES control system may identify configuration setting values to be implemented in a resource production unit in order to optimize production of a resource. Such configuration setting values may correspond to settings to be implemented at various control mechanisms in the resource production unit in order to control the operation of process components. In some cases, an initial set of configuration setting values may be generated for a resource production unit. For example, simulator software may be used to test configurations and may output a set of configuration setting values that are estimated to result in optimization of resource production by the resource production plant. In some cases, the simulator software may be used to determine an optimal status (e.g., temperature, pressure, etc.) for each of the process components involved in the resource production process. In such cases, the IES control system may be configured to calculate configuration setting values for control mechanisms that are estimated to result in the optimal status. For example, given a particular amount of pressure to be maintained in a process component, the IES control system may be configured to calculate a degree to which one or more valves should be opened/closed to achieve that amount of pressure.

It should be noted that the IES control system may be implemented within a power plant system, within a resource production plant, or as a standalone computing device (e.g., a server) in communication with other electronic devices. In embodiments in which the IES control system is external to a resource production plant, the IES control system may be configured to identify an optimal set of configuration settings and to provide that set of configuration settings to the resource production plant.

In embodiments in which the IES control system is implemented within a resource production plant, the IES control system may be configured to implement a set of configuration setting values by generating instructions to be implemented by each of the control mechanisms implemented in the resource production unit. While the resource production unit is being used to generate a resource, sensor data may be used to determine whether the status of a particular process component is optimal, for example, with regards to efficiency and safety. In the event that a status of a process component (as determined based on sensor data) is not optimal (e.g., not within a suitable range), the IES control system may be configured to adjust one or more configuration setting values to achieve a more optimal status.

An IES control system may be configured to determine which resources should be produced based on a number of factors (e.g., a current stockpile, need, etc.) and allocate steam and power to the production of those resources. In some cases, resources may be prioritized based on an amount of the respective resources that is currently stockpiled. In some cases, a default type of resource may be prioritized/produced any time that the power plant is producing excess power. In these cases, once a storage tank for the prioritized resource has been filled, a different resource may be prioritized and that resource may be produced instead.

Embodiments provide advantages over conventional systems. It should be noted that while optimization of resource production processes is desirable, there is no set of configuration settings that is optimal for all scenarios. For example, while steam produced by a power plant is used in resource production, the temperature of such steam may vary based on a number of factors, such as based on a distance of the resource production plant from the power plant. Accordingly, the configuration settings that are optimal for one resource production unit may be different from the configuration settings that are optimal for another resource production unit. Embodiments of the disclosure allow for adjustment of various configuration settings in order to achieve an optimal configuration for each individual resource production unit.

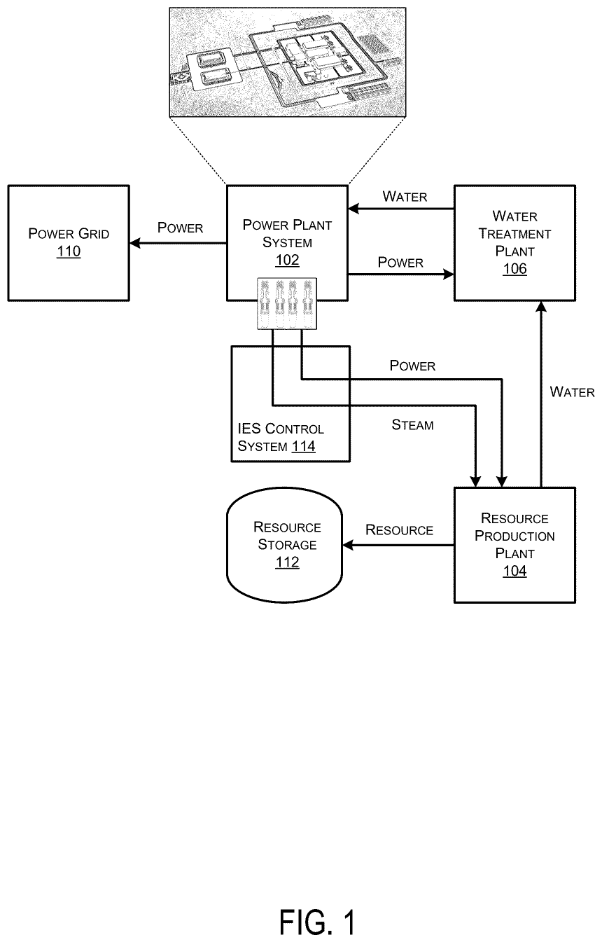

FIG. 1 is a schematic diagram of an integrated energy system that includes a power plant system in accordance with at least some embodiments. In the illustrated embodiment, the power plant system 102 is configured for use in one or more industrial processes/operations and, more particularly, for use in resource production/recovery operations. In some embodiments, the power plant system 102 comprises a nuclear power plant system comprising nuclear reactor modules and related components. The nuclear reactor may comprise small modular reactors, microreactors, and/or other types of advanced reactors. The power plant system 102 can be located at or near the location of resource production plant 104. In some embodiments, the power plant system 102 may be terrestrial or extraterrestrial. The power plant system 102 can also be deployed on land or water. For example, the power plant system 102 can be a permanent or temporary installation built at or near (e.g., roughly 1 km from) the location of the resource production plant 104 or can be a mobile, or partially mobile, system that is moved to and assembled at or near the location of the resource production plant 104.

In the illustrated embodiment, the power plant system 102 is operably coupled to a resource production plant 104 and/or a water treatment plant 106. The resource production plant 104, water treatment plant 106, and/or additional components for carrying out a resource production operation can be referred to as a primary subsystem for carrying out the resource production operation. The power plant system 102 can also be operably coupled to a power grid 110. The resource production plant 104 and/or additional components (e.g., resource storage 112) can be referred to as a secondary subsystem for carrying out a secondary process.

In embodiments, the power plant system 102 can be electrically coupled to the water treatment plant 106, the resource production plant 104, and the power grid 110 for selectively providing electricity (e.g., power) thereto. Similarly, individual ones of steam output paths of the power plant system 102 can be fluidly coupled to the resource production plant 104 for selectively providing steam thereto. In other embodiments, the power plant system 102 can be operably coupled to additional or fewer outputs and/or the various outputs can receive electricity and/or steam from other sources (e.g., conventional steam generators, conventional electricity sources, etc.).

In embodiments, the power plant system 102 can be configured in a first operating state to provide electricity to the water treatment plant 106 (e.g., via one or more of the electrical output paths from an electrical power transmission system of the power plant system). The water treatment plant 106 can be a desalination plant, and/or other types of water treatment facility that are configured to produce high quality water that can be provided to the power plant system 102 for use in power generation/cooling. For example, the water treatment plant 106 can operate to demineralize and/or otherwise remove contaminants and/or unwanted material from a water source. The water treatment plant 106 can route the produced high-quality water to the power plant system 102, and the power plant system 102 can use the water to produce power along with a byproduct of high-quality steam. For example, the produced water can be used as a secondary coolant in a steam generator of one or more of the nuclear reactors. In some embodiments, the water treatment plant 106 can be omitted and the power plant system 102 can utilize water from other sources.

In some embodiments, in which the power plant system 102 provides steam and power to the resource production plant 104, that resource production plant 104 may use the combination of steam and power to produce a specific resource (e.g., chemical products, alternative fuels). In such cases, the amount of steam and power provided to the resource production plant 104 may be catered to achieve a specified production level for the resource. For example, the amount of power and steam directed to the resource production plant 104 may be an amount needed to produce a predetermined amount of the resource, which is then stored in resource storage 112. In some cases, steam provided by the power plant system 102 is condensed into liquid water during the resource production process and subsequently returned to the power plant system 102 (in some cases via the water treatment plant 106). For the purposes of this disclosure, an “amount” of steam may be quantified in any suitable manner. In some cases, such a quantity may refer to a temperature and rate of flow of steam. In some cases, such a quantity may refer to a total volume of steam.

During operation of the resource production plant 104 and the power plant system 102, an IES control system 114 may be implemented in order to affect operations of various components of the resource production plant 104. Such an IES control system 114 may be responsible for directing steam and/or electricity produced from the power plant system 102 to various components implemented within the resource production plant 104. In some embodiments, a portion of the resource production process is carried out in each of several “units” included in the resource production plant 104, each of which may be capable of producing a predetermined amount of the resource. In such embodiments, a needed/desired amount of a resource can be produced at the resource production plant 104 by operating an appropriate number of nuclear reactor modules of the power plant system 102 to allocate desired amounts of steam (i.e., at optimal temperature, pressure, etc.) and/or electricity to the resource production plant 104. Within a unit of the resource production plant 104, a process for generating the resource is implemented across a series of components, each configured to perform a portion of the resource generation process. In the resource production plant 104, each component may be coupled with one or more sensors capable of collecting information about the operation of that component. Additionally, the component may be coupled with a control device (e.g., a control valve) configured to block, adjust, enable, or otherwise control one or more operations of the respective component.

In some embodiments, the IES control system 114 is in communication with individual nuclear reactor modules of the power plant system 102 that may be dedicating its output steam and power to a resource production process. Such nuclear reactor modules can be activated remotely by the IES control system 114 in order to affect the portion of the process performed by the respective component of the resource production plant 104. For example, the IES control system 114 may close or open a valve for adjusting pressure or manipulate nuclear reaction process in a reactor vessel of the nuclear reactor module. Additionally, the IES control system 114 receives sensor data from a number of sensor devices of an instrumentation and control system that are coupled with the various components of each nuclear reactor module. The sensor data may include information (e.g., metrics) about the operation of the respective component of the nuclear reactor modules. For example, the sensor data may include information about water chemistry, temperature, and pressure inside a containment vessel and/or reactor vessel of the module or density of the materials located in a containment vessel and/or reactor vessel. The IES control system 114 may be configured to compare the received sensor data in order to determine if that information deviates from expected information. In the event that the received sensor data does not match what is expected, the IES control system 114 may make an adjustment to one or more components in the nuclear reactor module via the respective control devices coupled to the one or more components.

In some embodiments, a secondary power production plant may be implemented in order to provide additional power to the power grid 110 when such additional power is needed/desired. In such embodiments, the secondary power production plant consumes resources from resource storage 112 in order to generate power. For example, the resource production plant 104 may include a hydrogen production plant configured to generate hydrogen (e.g., H₂) that is subsequently stored in one or more storage tanks (e.g., resource storage 112). Such hydrogen can then be used to power gas turbines (e.g., an example of a secondary power production plant) to produce additional power.

In some cases, power generated by the power plant system 102 is directed away from the power grid 110 to the resource production plant 104 in order to produce some desired amount of a resource during times at which power demand on the power grid is relatively low. During such times, a stockpile of that resource may be stored in the resource storage 112 for later use. At a subsequent time, as the power demand on the power grid 110 becomes higher, the power plant system 102 may redirect power away from the resource production plant 104 and back to the power grid 110.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

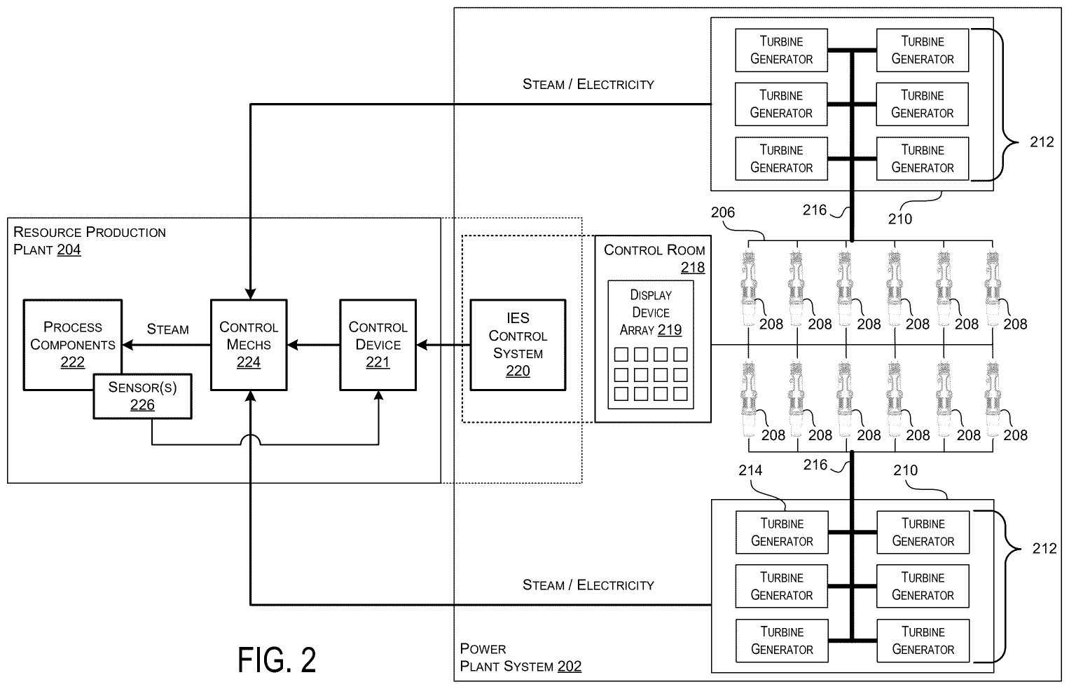

FIG. 2 provides a schematic view of a resource production plant operating in tandem with a power plant system in accordance with various embodiments as disclosed herein. A power plant system 202 may be an example of the power plant system 102 described in relation to FIG. 1 above. Likewise, a resource production plant 204 may be an example of the resource production plant 104 as described in relation to FIG. 1 above.

In exemplary embodiments, power plant system 202 includes power-generation module (PGM) assembly array 206. PGM assembly array 206 includes one or more PGM assemblies, such as but not limited to PGM assembly 208. In the exemplary system shown in FIG. 2, and in at least one embodiment, PGM assembly array 206 includes twelve PGM assemblies 208. However, in other embodiments, the number of PGM assemblies 208 included in a PGM assembly array 206 includes more or less than twelve PGM assemblies. A PGM housing may house at least a portion of the PGM assembly array 206.

In some embodiments, one or more generator housings 210 house a generator array 212. Generator array 212 includes one or more devices that generate electrical power or some other form of usable power from steam generated by the PGM assembly array 206. Accordingly, generator array 212 may include one or more electrical generators, such as but not limited to a turbine generator 214. As shown in FIG. 2, and in at least one embodiment, generator array 212 includes twelve electrical turbine generators 214. However, in other embodiments, the number of electrical generators included in generator array 212 includes more or less than electrical generators. In at least one embodiment, there is a one-to-one correspondence between each PGM assembly included in PGM assembly array 206 and each electrical generator included in all of the generator arrays 212.

A steam bus 216 may route the steam generated by each PGM assembly array 206 to the respective generator array 212. The steam bus 216 may provide the one-to-one correspondence between the PGM assemblies included in the PGM assembly array 206 and the electrical generators included in the generator array 212. For instance, the steam bus 216 may ensure that the steam generated by a particular PGM assembly is provided only to a particular electrical generator. The steam bus 216 may additionally ensure that the steam provided to the particular electrical generator is generated only by the particular PGM assembly. A power bus may be used to transmit the electrical power generated by the generator array 212 of power plant 202 to other structures. In some cases, electrical power generated by the power plant 204 may be distributed to various destinations in accordance with allocations assigned by a control room 218 that includes various components configured to manage operations of the power plant 204. As depicted, the control room 218 may include at least a display device array 219 that includes multiple display devices, each of which may be dedicated to management of a PGM assembly 208 or another suitable component. In some embodiments, an IES control system 220 may be implemented on, or in communication with, one or more computing devices operating within the control room 218.

As depicted, the power plant 202 may be in communication with a resource production plant 204 that is configured to produce one or more desired resources. A resource production plant 204 may include one or more computing device that is configured to manage allocation of steam and power to various process components 222 operating within the resource production plant 204. In some embodiments, the IES control system 220 may be implemented within the resource production plant 204. The IES control system 220 may be an example of the IES control system 114 as described in relation to FIG. 1 above.

In the resource production plant 204, a number of resource production units, each of which may include a set of process components 222. The process components 222 may be arranged within a resource production unit to perform a portion of a resource production process. The process components may operate in parallel (e.g., substantially simultaneously) or in a series (e.g., output from on is receive as input by another). A control device 221 (which may be the IES control system 220 or another suitable device) may be configured to affect operations of the resource production plant 204 by providing instructions to one or more control mechanisms 224 in communication with the various process components 222. Such instructions may cause the respective control mechanism 224 to implement a specified setting/configuration, which may affect the resource production process and/or an environment in which the resource production process is being performed.

An IES control system 220 (or another suitable device) may be configured to further affect operations of the resource production plant 204 by controlling input/output of one or more PGM assembly 208. In some cases, this may involve providing instructions to one or more control mechanisms of the PGM assembly 208. For example, a control mechanism may include a valve and such instructions may cause closing and/or opening of that valve by some amount to limit/allow input to the respective PGM assembly 208. In another example, such instructions may cause an amount of steam and/or power (e.g., electricity) provided to the process components 222 to be increased or decreased in order to increase or decrease production by the respective process component. In this example, the IES control system 220 may be in communication with a steam bus that acts as an egress point for steam leaving the plant (e.g., steam traveling to the resource production plant). In such cases, the IES control system 220 may be configured to adjust one or more settings of the steam bus to cause it to increase or decrease steam being provided to the resource production plant 204.

In embodiments, one or more sensor 226 may be coupled with, or positioned near, the process components 222. In such embodiments, the sensors 226 may obtain information about one or more conditions associated with the process component and/or an environment in which the process component 222 is located. Sensors 226 may include a variety of different types of sensors. For example, sensor 226 may include sensors that measure throughput in one or more transit components (e.g., pipes) that convey input/output associated with the process component 222. In another example, sensor 226 may include a sensor that measures a temperature (e.g., a thermometer) and/or pressure (a barometric pressure sensor) of substances being processed by the process component 222. The control device 221 may be implemented on a computing device that receives information from each of a number of sensors 226 via a sensor data bus. In some embodiments, the sensor data received by the control device 221 from each of the sensors 226 may be provided to the IES control system 220 in order to update information to be used in generating configuration settings.

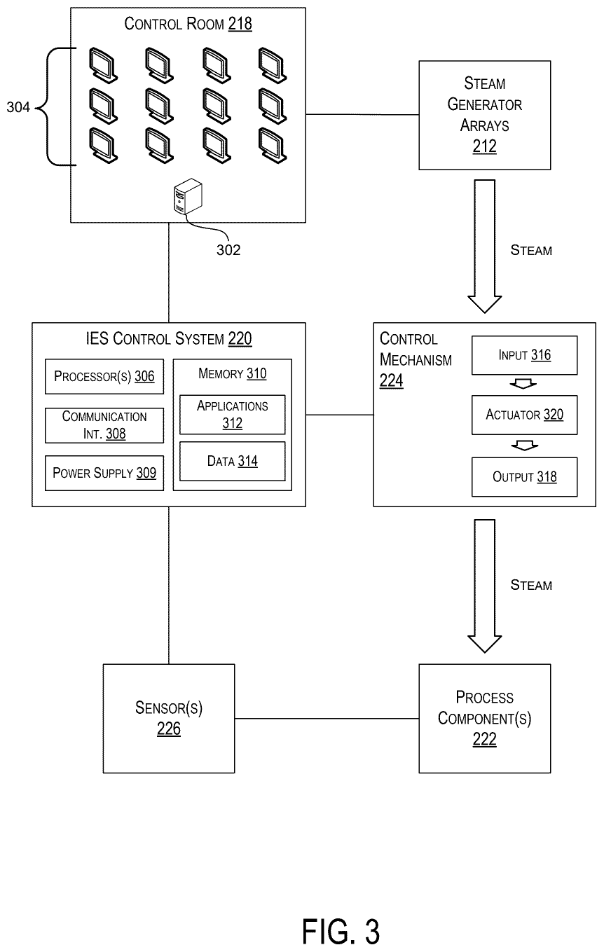

FIG. 3 provides a schematic view of an IES control system in communication with a control room of a power plant system to implement techniques for management of resource production in accordance with embodiments. As depicted in FIG. 3 (and as described elsewhere), the control room 218 may be in communication with a number of steam generator arrays 212 and/or PGM assemblies 208 within a PGM array 206. Additionally, an IES control system 220 may be in communication with the control room 218 as well as a number of control mechanisms 224 for the power plant system components (e.g., PGM assemblies) or the resource production plant components.

Control room 218 may include at least one computer device 302 and an array of display devices (e.g., display device array 304) in some embodiments. Control room 218 may be an example of, or at least include similar features to, control room 218 discussed in conjunction with at least FIG. 2. Display device array 304 may includes one or more display devices. Note that while the element is labeled as a display “array,” the one or more displays may not be arranged in an array and may instead be arranged in any suitable configuration. The computer device 302 may include one or more hardware processors configured to execute one or more stored instructions that may comprise one or more processing cores. Further, the computer device 302 may include one or more communication interfaces configured to provide communications between reactor modules and various instrumentation & control (I&C) systems. In some embodiments, an IES control system 220 may be implemented on the computer device 302.

In an exemplary case, the display device array 304 includes twelve display devices. In this exemplary case, there is a one-to-one correspondence between each PGM assembly included in a PGM assembly array (e.g., PGM assembly array 206) and a respective one of the display devices included in display device array 304. Accordingly, there may be more or less than twelve display devices included in display device array 304 if there are more or less than twelve PGM assemblies.

In embodiments in which the IES control system is implemented within a power plant system, the IES control system may be configured to generate a set of configuration settings that may be implemented at a resource production plant. In such embodiments, the configuration settings may be provided to a control device (e.g., control device 221 of FIG. 2) which may then implement those configuration settings across various control mechanisms 224.

In embodiment in which the IES control system is implemented within a resource production plant, the IES control system 220 may affect resource production by a process component 222 via access to one or more control mechanisms 224 and may include any suitable computing device configured to perform at least a portion of the functionality described herein. In some cases, the IES control system 220 may be a server computing device. The IES control system 220 may include one or more hardware processors 306 configured to execute one or more stored instructions. Such processor(s) 306 may comprise one or more processing cores. Further, the IES control system 220 may include one or more communication interfaces 308 configured to provide communications between the IES control system 220 and other devices, such as the control room 218, the control mechanism(s) 224, and/or the sensor(s) 226. In some embodiments, the communication interfaces 308 includes one or more data bus configured to receive information from various sensors 226. Additionally, the IES control system 220 may include one or more power supply 309, such as a battery or a power plug.

As used herein, a processor may include multiple processors and/or a processor having multiple cores. Further, the processor(s) may comprise one or more cores of different types. For example, the processor(s) may include application processor units, graphic processing units, and so forth. In one instance, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

Memory may include volatile and nonvolatile memory, removable and non-removable media implemented in any method or technology for storage of information, such as computer-readable instructions, data structures, program component, or other data. The memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information, and which can be accessed by a computing device. The memory may be implemented as computer-readable storage media (“CRSM”), which may be any available physical media accessible by the processor(s) to execute instructions stored on the memory. In one basic instance, CRSM may include random access memory (“RAM”) and Flash memory. In other instances, CRSM may include, but is not limited to, read-only memory (“ROM”), electrically erasable programmable read-only memory (“EEPROM”), or any other tangible medium which can be used to store the desired information, and which can be accessed by the processor(s).

Further, functional components may be stored in the memory, or the same functionality may alternatively be implemented in hardware, firmware, application specific integrated circuits, field programmable gate arrays, or as a system on a chip (SoC). In addition, while not illustrated, the memory may include at least one operating system (OS) component that is configured to manage hardware resource devices such as the communication interface 308, input/output (I/O) devices of the respective apparatuses, and so forth, and provide various services to applications or components executing on the processor(s).

The IES control system 220 may also include memory (e.g., computer-readable media) 310 that stores various executable components (e.g., software-based components, firmware-based components, etc.). The memory 310 may store components to implement functionality described herein. While not illustrated, the memory 310 may store one or more operating systems utilized to control the operation of the one or more devices that comprise the IES control system 220. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The memory 310 may include portions, or applications 312, that configure the IES control system 220 to perform various operations described herein. An application 312 (e.g., a software application) may be any suitable set of computer executable instructions that causes a computing device perform a function. In embodiments, the memory 310 may include some combination of applications (or other components) configured to implement the described techniques. Particularly, the applications may implement techniques to achieve a specified production level for one or more resources. For example, the IES control system 220 may receive an indication of a desired level of production for a resource and may generate instructions to cause a resource production plant to achieve the desired level of production. In another example, the IES control system may receive an indication of a level of excess steam and/or power being generated by a power plant. In this example, the applications may identify a level of resource production that corresponds to the indicated excess steam/power and generate instructions to cause a resource production plant to achieve the identified level of production.

Particularly, the IES control system 220 may include an application configured to control operations as performed by one or more process components. To do this, the IES control system may identify one or more configuration settings to be applied to control mechanisms coupled with the various process components. For example, the IES control system may identify a level of input/output flow that should be allowed to/from a process component 222 in order to optimize the production of a resource. A mapping of configuration settings to be applied to particular control mechanisms in order to achieve a desired result may be stored as data 314. For example, data 314 may store a correlation between one or more configuration settings and an amount of resource generated during a resource production process. In some cases, one or more configuration settings may be relative to other configuration settings.

The IES control system 220 may control a resource production process through interactions with one or more control mechanisms. In some cases, the IES control system 220 provides instructions directly to the one or more control mechanisms. In other cases, the IES control system 220 generates a set of configuration settings that is then provided to a control device of the resource production plant. In various embodiments, a control mechanism 224 may be any suitable mechanism for adjusting operation of a process component 222. In some cases, the control mechanism 224 may be a valve that is configured to control an amount of resource going to or from a process component 222. In such a case, the valve (control mechanism 224) may include an input 316, and output 318, and one or more actuators 320. An actuator is a part of a device or machine that helps it to achieve physical movements by converting energy, often electrical, air, or hydraulic, into mechanical force. In this example, the actuator 320 can be activated to increase or decrease a size of an opening between the input 316 and the output 318, resulting in increasing or decreasing the flow of a resource to or from the process component 222.

While the control mechanism is depicted as being separate from the process component 222, it may alternatively be implemented within the process component 222 itself. For example, the process component 222 may be configured to receive instructions from the IES control system 220 and make one or more adjustments based on those instructions.

In some embodiments, the applications 312 may include one or more trained machine learning models configured to learn and implement optimal configuration settings for a resource production process. In some embodiments, the applications 312 may be further configured to receive information collected from one or more sensors 226. In such cases, the applications 312 may be further configured to compare the information collected from the sensors 226 to expected information. In yet further embodiments, the applications 312 may be configured to provide further instructions to the control mechanism 224 to cause it to adjust a portion of the process based on a discrepancy between the expected information and the information collected from the sensors 226.

Communication interface 308 may enable data to be communicated between electronic devices. The communication interface may include one or more network interface controllers (NICs) or other types of transceiver devices to send and receive messages over network(s). For instance, the communication interface may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (Wi-Fi), or any other PAN message protocol. Furthermore, the network interface(s) may include a wide area network (WAN) component to enable messaging over a wide area network.

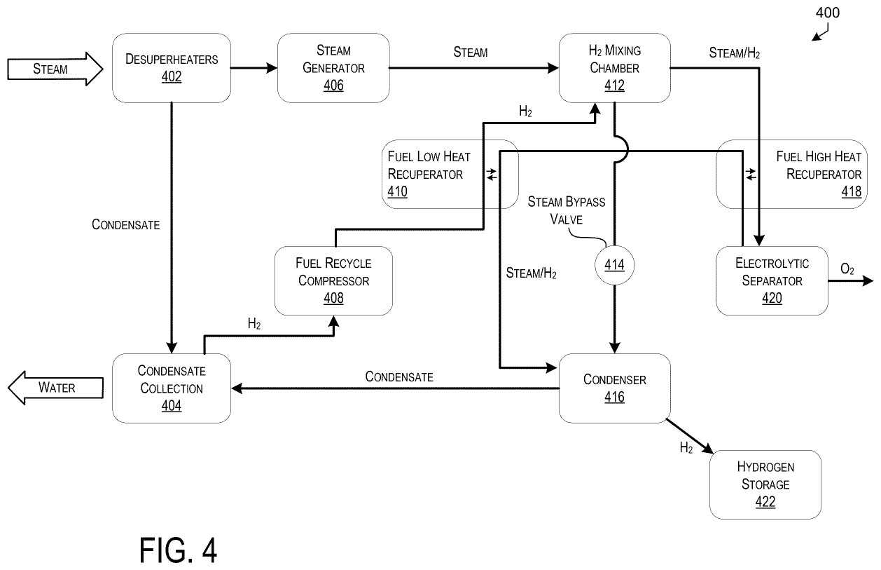

FIG. 4 depicts a block diagram illustrating an example of a process for producing hydrogen gas using excess steam and power generated by a power plant in accordance with at least some embodiments. In embodiments, a resource production plant (e.g., resource production plant 104) may include multiple units that each include a number of process components for performing resource production. In embodiments, an IES control system may control operations of one or more nuclear reactor modules of a power plant to allocate different amounts of excess power/steam to the resource production plant. For example, the number of units that are spun up may be determined based on a power/steam consumption associated with the resource production process as performed by the resource production plant.

As noted elsewhere, steam is supplied to the resource production plant from a power plant. In some cases, steam from the power plant is supplied to a common header for the resource production units at a specified pressure and temperature. For example, in an exemplary process for producing H₂, steam may be provided at 440 psia as well as at 537° F. In such cases, the power plant may be located some distance from the resource production plant (e.g., 1 km). Accordingly, the steam may be provided via at least one supply pipe that is insulated to maintain proper steam conditions.

In the exemplary process 400, steam received at a resource production unit is initially fed to desuperheater components 402. Particularly, the steam is first fed to a high-pressure desuperheater component. The steam exiting the high-pressure desuperheater component is throttled to 121 psia (8.3 bara). This steam enters a separator to collect and drain any condensate. The condensate will drain to a condensate collection tank 404, to be provided back to the power plant (e.g., by way of a water treatment plant). The throttled steam will next enter a low-pressure desuperheater. In the process 400, steam exiting the low pressure desuperheater will be close to saturation temperature.

During the process 400, the condensate collection tank 404 should start with enough water to support the H₂ production process. The level of water in a condensate collection tank 404 should be maintained at roughly 50% capacity. During operation, the tank is maintained at a particular pressure (e.g., 101.5 psia) and a control valve is used to drain the tank to maintain that level. If the tank level goes above a high setpoint, two condensate forwarding pumps may be used to help in draining the tanks. One or more of such pumps may auto-start if a level of water in the condensate collection tank 404 is above a first threshold capacity. In such cases, the pump may also auto-stop when the level of water in the condensate collection tank 404 is below a second threshold capacity.

In embodiments, the condensate collection tank 404 has an off-gas pump to remove non-condensable materials. Water drained from the collection tank may sent to a drain cooler. The drain cooler is used to heat up the liquid used in the H₂ generation process while also cooling off the condensate being returned to the power plant. Water exiting the drain cooler may still be too hot to be returned to the plant. In such cases, quench water can be used to cool off such condensate, and the condensate is then returned to the unit that is supplying the steam.

The steam exiting the desuperheater components 402 will enter a steam generator component 406 (e.g., a boiler). The steam generator is configured to condition the steam in order to provide steam to downstream process components at a particular pressure and/or temperature. For example, the steam generator component 406 may provide steam at 75 psia and 442° F. The steam generator component 406 provides steam to a H₂ mixing chamber component 412.

In some embodiments, H₂ gas is pulled from the condensate collection tank 404 by a fuel recycle compressor component 408 and is forwarded to the fuel low heat recuperator component 410. The fuel recycle compressor component 408 should be in service when the process 400 is initiated. During the process 400, an outlet valve can be modulated to control the recycle fuel flow and maintain the concentration of H₂ and steam entering a downstream electrolytic separator component 420 at a 50/50 by volume ratio. The H₂ gas forwarded by the fuel recycle compressor component 408 enters the fuel low-heat recuperator component 410. The H₂ gas may be heated (via a heat exchange) by the “hot side” gases that are being conveyed to the condenser.

H₂ gas exiting the fuel low heat recuperator component 410 enters a H₂ mixing chamber component 412. In the hydrogen generation process, the mixture of steam and H₂ is controlled to maintain a proportion of 50% steam and 50% H₂ by volume. A steam flow control valve is used to admit steam from the steam generator to maintain this concentration. In local control, the steam flow setpoint may be calculated based on the amount of H₂ flow entering the H₂ mixing chamber component 412 (e.g., in order to maintain the H₂ concentration at 50% by volume). The setpoint may also maintain a minimum level of steam flow.

A steam bypass valve 414 is used to control the steam pressure at the H₂ mixing chamber component 412. During unit startup, the steam generator component 406 pressurizes the steam to 75.5 psia and steam flow is bypassed to the condenser using the bypass control valve 414. When the unit is in H₂ generation operation, the pressure setpoint for the bypass control valve 414 can then be raised to allow the bypass control valve 414 to close during this operation. This also allows the bypass control valve 414 to serve as a pressure relief valve/steam overflow control.

The mixture of steam and H₂ is fed by the H₂ mixing chamber component 412 to a fuel high-heat recuperator component 418. In some embodiments, the mixture is heated (via a heat exchange) by the “hot side” gases that are being conveyed to the condenser. The mixture then enters an electric heater. The electric heater has a variable heat output and is used to control the temperature of the mixture to a specific temperature (e.g., 1382° F. or 750° C.). If the temperature of the mixture goes above a high setpoint threshold (e.g., 1450° F.), the heater will turn off. The electric heater of the fuel high-heat recuperator component 418 should only be in operation if there is flow passing through it.

The mixture of steam/H₂ exiting the fuel high-heat recuperator component 418 enters one or more electrolytic separator component 420. A processor for the electrolytic separator component 420 may calculate the electro-chemistry based on one or more detected conditions of the steam/H₂ mixture. As noted elsewhere, the one or more detected conditions of the steam/H₂ mixture may be determined based on information obtained using sensors coupled to various components. For example, such sensors may obtain information that pertains to a temperature, a pressure, and/or a voltage associated with the mixture.

In the hydrogen generation process 400, steam (H₂O) is broken in hydrogen and oxygen molecules. In some cases, this may involve the use of an electrolysis process. Electrolysis processes are typically classified into three basic categories based on the applied electrolyte: (1) high temperature steam electrolysis (HTSE) or solid oxide electrolysis, (2) liquid alkaline (LA; e.g., alkaline water) electrolysis, and (3) proton exchange membrane (PEM) water electrolysis. Both LA electrolysis and PEM electrolysis are low temperature electrolysis techniques. HTSE has the highest hydrogen production efficiencies when input steam temperature is operated in a temperature range of greater than 700° C., and is suitable for constant hydrogen production. LA electrolysis and PEM electrolysis are well-developed technologies that are commercially available and typically operate at much lower temperature and are less efficient than HTSE systems. PEM electrolysis systems have a more compact design than LA electrolysis systems and also have a lower operational input water temperature (typically <100° C.). It should be noted that any suitable electrolysis process may be performed to separate oxygen and hydrogen within the electrolytic separator component 420. However, given the high-temperature of the steam/H₂ mixture in the electrolytic separator component 420, HTSE is likely most suitable.

Within the electrolytic separator component 420, the hydrogen molecules remain on a first side of the cell, while the oxygen molecules are pulled through a cell ceramic. The mass flow exiting the first side will hence be less than the mass flow entering. Additionally, while the steam/H₂ mixture entering the electrolytic separator component 420 will have a 50/50 ratio, the steam/H₂ mixture exiting the electrolytic separator component 420 will be 75% H₂ by volumes.

The oxygen (e.g., O₂) produced in this manner may be stored and/or used in a downstream system. In some cases, the O₂ is combined with another element to create oxide that can be used in fuel cells, such as solid oxide fuel cells (SOFC). Such fuel cells can be later used to generate electrical power through the oxidization of fuel (e.g., H₂ gas as produced via the process 400).

The steam/H₂ mixture leaves the electrolytic separator component 420 and enters the “hot side” of the fuel high-heat recuperator component 418. As noted above, heat is exchanged between this mixture and the mixture exiting the H₂ mixing chamber component 412. Hence, this mixture is cooled and then enters the “hot side” of the fuel low heat recuperator component 410. As noted above, heat is then exchanged between this mixture and the H₂ gas exiting the fuel low-heat recuperator component 410 to further cool the mixture. The mixture is subsequently fed into a condenser component 416.

The condenser component 416 allows the water within the steam/H₂ mixture to condense into liquid form, which is subsequently drained into the condensate collection tank 404. Once the steam in the mixture has been condensed into water, the remaining volume of gas will be almost 100% H₂. That H₂ gas is then pumped into a hydrogen storage tank 422 (which may be an example of resource storage 112 as described in relation to FIG. 1 above). The H₂ gas stored in the hydrogen storage tank 422 may then be consumed by another entity (e.g., by a secondary power production plant) to generate power.

In embodiments, H₂ gas stored in the hydrogen storage tank 422 is stored at 10,000+ psia. When consumed during secondary power generation, hydrogen is admitted through an expander to reduce pressure (e.g., expand) to a useable level. In such embodiments, a flow control valve is used to control the flow from the outlet of the H₂ expander to the inlet of the fuel low heat recuperator component 410.

Inter-stage control valves of the H₂ expander can be used to control a downstream hydrogen storage tank to store H₂ gas at 100 psia (6.9 bara). Each stage of the expander has an inlet valve and a bypass valve. As the pressure in that hydrogen storage tanks drops, the inlet stage of the compressor will shift down in stages. The upstream stage inlet valve will close, and the new inlet stage bypass will open.

In embodiments, each of a number of stages in the expander has an electric heater to maintain temperature between stages. As the H₂ pressure continues to be reduced (e.g., expanded), there is a significant temperature drop. Hence, the heaters will maintain the temperature between stages at 104.5° F. (40° C.).

As noted elsewhere, an IES control system may affect each of the process components 402-422 included in the resource production plant and used in a resource production process. Particularly, the IES control system may provide instructions to each of the control mechanisms (e.g., valves) coupled with the various process components in order to maintain/achieve the above-noted objectives. In some cases, the IES control system may cause the various process components to be reconfigured to achieve production of a specified amount of resource (e.g., H₂ gas).

The IES control system may maintain information about correlations between configuration settings (e.g., valve settings, pressure targets, temperature targets, etc.) for the various process components. Such correlations may indicate a relationship between the configuration settings for the various process components and/or a relationship between the configuration settings for process components and an amount of resource to be produced. Hence, the IES control system may be configured to, upon receiving an indication of an amount of resource to be produced (or an amount of steam/power to be used) automatically (e.g., without human interaction) identify an appropriate set of configuration settings to be applied to control mechanisms coupled with the process components 402-422.

Additionally, the IES control system may be configured to receive information from one or more sensors coupled with the various process component. This may include process components involved in the resource production process as well as process components involved in the power production process. Metrics calculated from such information may be compared to expected metrics in order to determine whether the respective process component is operating as directed. Upon making a determination that the metrics obtained from the sensor information in relation to a particular process component varies from expected metrics for that process component, the IES control system may be configured to adjust one or more values in a configuration setting stored in relation to that process component. In some cases, the IES control system may be configured to adjust an amount of steam and/or electricity that is being provided to the resource production plant/unit by a power plant system (e.g., by increasing or decreasing an amount of steam produced/provided). In some cases, to do this, the IES control system may be configured to provide a series of instructions to the control mechanism coupled with the process component to make incremental changes. Once the IES control system has determined that the metrics obtained from sensor information are within a suitable range of the metrics expected for that process component, the IES control system may be configured to generate and store new configuration settings for that process component based on the current configuration.

It should be noted that while the exemplary resource production process 400 relates to a process for producing hydrogen gas using power and “waste” steam produced by a nuclear power plant, a resource production process is not limited merely to H₂ production. Other examples of suitable resource production processes using steam and power are described in detail in U.S. patent application Ser. No. 18/116,819, filed and Mar. 2, 2023, and titled “SMALL MODULAR NUCLEAR REACTOR INTEGRATED ENERGY SYSTEMS FOR ENERGY PRODUCTION AND GREEN INDUSTRIAL APPLICATIONS,” which is incorporated herein by reference in its entirety.

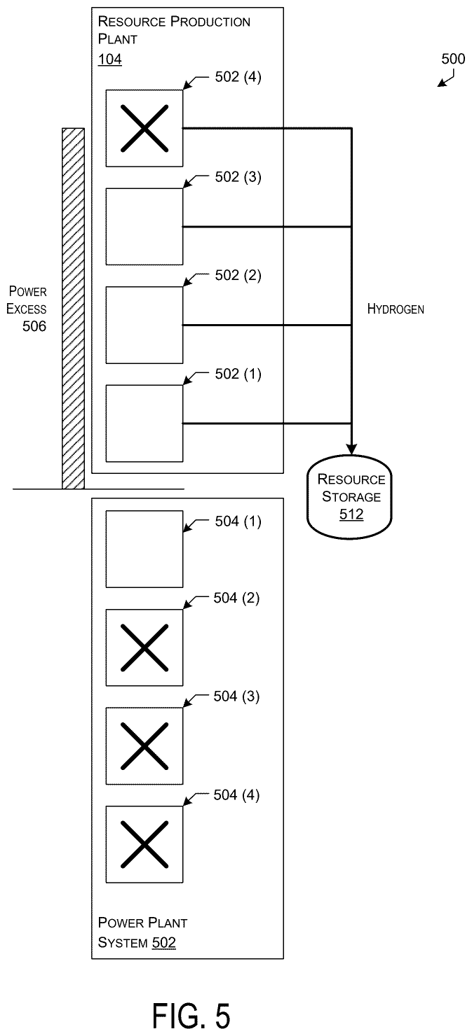

FIG. 5 depicts a block diagram illustrating a process for spinning up multiple nuclear reactor modules for resource production based on a difference between a current power production and a current power demand. Notably, the process 500 depicts an example in which an amount of power produced by a power plant (e.g., power plant system 102) is higher than an amount of power consumed by a power grid (e.g., power grid 110). In other words, the process 500 is representative of an example in which there is a power excess 506.

In the process 500, a resource production plant 104 (as described in relation to FIG. 1 above) may include a number of resource production units 502 (1-4), each of which include a set of process components configured to perform a resource production process. For example, a resource production unit for producing H₂ gas may include the process components 402-422 as described in relation to the H₂ production process 400 of FIG. 4 above. In some embodiments, each of the resource production units 502 may consume a specified amount of power/steam per some period of time and may produce a specified amount of resource over that period of time. In other embodiments, configuration settings associated with various process components within each unit may be adjusted to cause one or more resource production unit 502 to produce a specified amount of resource. It should be noted that a power plant may produce a fixed amount of power in some scenarios. For example, a module of a nuclear power plant may produce a fixed amount (e.g., 50 MW) of power, whereas the power plant may include some number of those modules. In this example, a power plant that includes 12 modules that each produce 50 MW of power would have a maximum power production capacity of 600 MW. Accordingly, the number of resource production units 502 that are included in a resource production plant may be selected such that the total power/steam consumption by those resource production units 502 is less than (or equal to) a total power produced by the power plant.

As noted elsewhere, a power plant system (e.g., power plant system 102 as described in relation to FIG. 1 above) may include a number of power production modules 504 (1-4), each of which are configured to generate power. Each power production module 504 may be a PGM as described elsewhere. Note that while FIG. 5 depicts a scenario that includes four such power production modules, the power plant system may include less than or more than four. Additionally, any number of power production modules 504 may be active upon initiation of the process as described in FIG. 5. For example, power module 504 (1) may be active and generating power that is provided to a power grid when the process is initiated while other power production modules (e.g., 504 (2-4)) remain inactive.

It should be noted that while a power excess or a power deficiency may be determined based on power usage data received from a power grid, there are other indicia that may be used to determine if and/or how many resource production units 502 should be spun up. For example, such a determination may be made based on a current price of power usage. In such an example, if a price of power is below a first threshold, then a portion of power produced by the power plant may be redirected to spinning up a first resource production units 502 (1) of the resource production plant. One skilled in the art would recognize that redirecting a portion of the power provided to the power grid should result in increases to the current price of power usage.

If, after spinning up a resource production units 502 (1), the price of power remains below (or subsequently goes below) the first threshold, then a second portion of the power produced by the power plant is redirected to spinning up a second resource production units 502 (2) of the resource production plant. This may continue, with multiple resource production units 502 (1-3) being spun up until the price for power usage rises above a second threshold (which may be the same as or higher than the first threshold), at which point one of the resource production units 502 is spun down and the portion of power directed to that resource production unit is once more directed to the power grid. One skilled in the art would recognize that redirecting a portion of the power back to the power grid should result in a decrease to the current price of power usage.

This process of spinning down resource production units 502 may also be repeated until all of the resource production units 502 are spun down. Hence, in some cases some number of resource production units 502 may be spun up at any given time in order to maintain power usage prices between the first and second threshold. Note that if there are no resource production units 502 currently spun up and the price of power rises above a third threshold, then one or more power production modules 504 may be spun up.

As noted above, the process 500 is representative of a scenario in which the demand for power on a power grid is less than the amount of power currently being generated by a power plant that supplies power to the power grid. In other words, the process 500 is relevant to a scenario in which there is a power excess 506 even with only power production module 504 (1) being active.

In embodiments, when there is a power excess 506, an IES control system is configured to spin up a number of resource production units 502. In some cases, the IES control system may determine a number of resource production units 502 to be spun up based on an amount of power associated with the power excess 506. More particularly, the IES control system may determine a set of the resource production units 502 to be spun up based on a total amount of power/steam consumed by that set of resource production units 502 being less than the power excess 506. In the depicted example, resource production units 502 (2-4) may be spun up whereas resource production units 502 (1) is not based on the amount of the power excess 506. Consider also that the set of resource production units 502 that are spun up may be further limited based on a total amount of steam (e.g., “waste steam”) that is being provided by the power plant.

Note that each of the resource production units 502 that are selected may perform a resource production process when they are spun up, such as the H₂ production process 400 as described in relation to FIG. 4 above. Each of the resource production units 502 may be configured to fill a resource storage 512 (e.g., a storage tank) with resources that are produced via the resource production process. In embodiments, the IES control system will not spin up any resource production units 502 if the resource storage 512 is full. To the extent that the power excess 506 is not consumed by the resource production units 502 that have been spun up, some portion of the power excess 506 may be stored in batteries or other power storage means.

It should be noted that while a single resource production plant 104 is depicted having multiple resource production units 502 (1-4), some embodiments may include multiple resource production plants, each of which generate a different type of resource. Alternatively, one or more of the multiple resource production units 502 within the resource production plant may be configured to produce a different type of resource than one or more other resource production unit. In such cases, the IES control system may be configured to identify which resource production unit 502 should be spun up in a given situation based on the amount of power excess 506 (as described above) as well as a resource production priority. For example, the IES control system may be configured to prioritize H₂ production as long as a resource storage 512 for H₂ is not full and other resources after the H₂ storage tank is full.

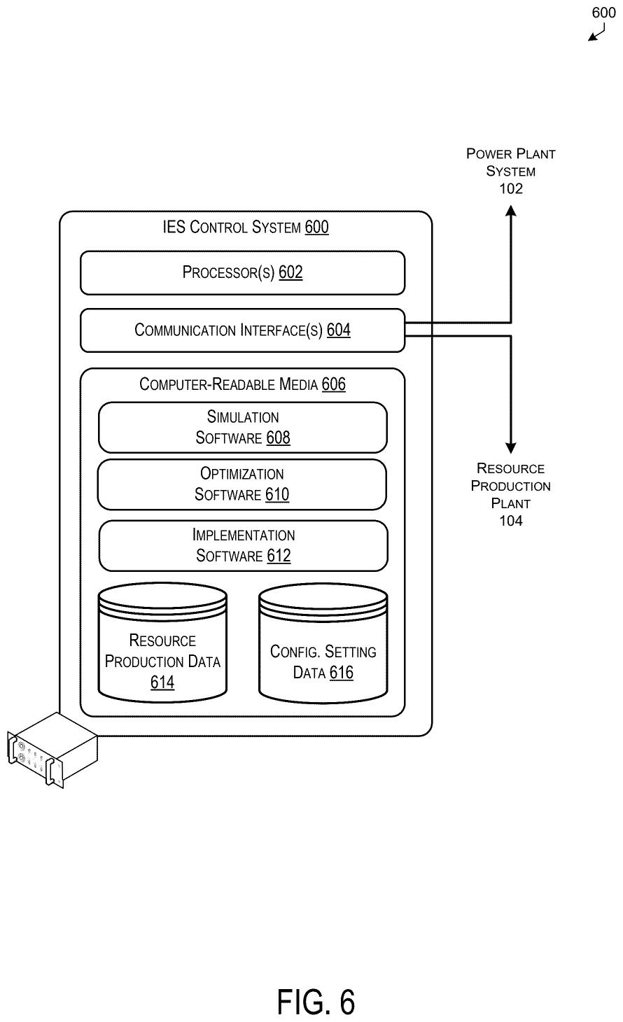

FIG. 6 depicts a component diagram of an example IES control system to be implemented in order to generate configuration settings for resource production in accordance with at least some embodiments. As depicted in FIG. 6, an IES control system 600 may be in communication with a one or more of a power plant system (e.g., power plant system 102) or a resource production plant (e.g., resource production plant 104). As noted elsewhere, the IES control system 600 may be implemented within a power production plant (e.g., in communication with a control room), within a resource production plant, or as a standalone computing device operating in communication with both entities.

The exemplary IES control system 600 may be an example of the IES control system 114 as described in relation to FIG. 1 above. It should be noted that the IES control system (or any other described computing component) may include a single computing device (e.g., a server device) or a combination of computing devices. In some cases, the IES control system may be implemented as a virtual system (e.g., via virtual machines implemented within a cloud computing environment).

As illustrated, the IES control system 600 may include one or more hardware processors 602 configured to execute one or more stored instructions. Such processor(s) 602 may comprise one or more processing cores. Further, the IES control system 600 may include one or more communication interfaces 604 configured to enable communications between the IES control system 600 and other devices, such as a computing device implemented at the power plant system 102, resource production plant 104, or any other suitable electronic device.

The IES control system 600 may also include computer-readable media 606 that stores various executable components (e.g., software-based components, firmware-based components, etc.). The computer-readable media 606 may store components to implement functionality described herein. While not illustrated, the computer-readable media 606 may store one or more operating systems utilized to control the operation of the one or more devices that comprise the IES control system 600. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 606 may include portions, or components, that configure the IES control system 600 to perform various operations described herein. For example, the computer-readable media 606 may include some combination of components configured to implement the described techniques. Particularly, the IES control system 600 may include a component configured to identify correlations between implemented configuration settings and resource production amounts at a resource production plant (e.g., simulation software 608), a component for identifying optimal configuration settings for achieving a resource production target (e.g., optimization software 610), as well as a component for causing implementation of configuration settings (e.g., implementation software 612). Additionally, the computer-readable media 606 may further maintain one or more databases, such as a database of conditions/components associated with a resource production plant (e.g., local status data 214) as well as a database of configuration settings implemented at (or to be implemented at) various control mechanisms of a resource production plant (configuration setting data 616).

A simulation software 608 may be configured to, when executed by the processor 602, receive information about a number of components and related control mechanisms implemented within a resource production plant. For example, the computer-readable media 606 may store information about the various components included in a resource production plant unit that are used in producing a target resource. In embodiments, such information may include metes and bounds for various control mechanisms that can be used to control operations of the respective components in the resource production plant. For example, the information may include an indication of a maximum flow of volume for a pipe that is fitted with a valve (i.e., control mechanism). In this example, the information may indicate that a flow of volume in that pipe can be set to anywhere from zero to the indicated maximum flow of volume by adjusting the valve. In some cases, the computer-readable media 606 may maintain information about a layout or configuration of the various components/control mechanisms implemented within a resource production plant. In such cases, the simulation software may be configured to simulate a virtual environment that is representative of the resource production plant environment using this information.

In embodiments, the simulation software may be configured to calculate or predict an amount of resource to be produced by the resource production plant given a specified set of conditions (which may include configuration settings) within a simulated environment. The simulation software may be configured to allow for configuration settings of various control mechanisms to be adjusted within the simulated environment. The simulation software may then adjust a predicted amount of resource to be produced by the resource production plant based on the new configuration settings.

An optimization software 610 may be configured to, when executed by the processor 602, determine a set of configuration settings that result in optimal resource production. When using the term “optimal” here, it should be noted that resource production can be optimized by minimizing or maximizing any suitable condition. For example, a set of configuration settings may be optimal if its implementation results in the resource production plant producing the greatest amount of resources using the least amount of steam and/or electricity. In another example, a set of configuration settings may be optimal if it results in production of a target amount of the resource within the shortest amount of time. In embodiments, the optimization software 610 is configured to work in conjunction with the simulation software 608.

In some cases, the optimization software 610 may begin its analysis with a default set of configuration settings. In such cases, the optimization software may adjust various configuration settings to observe an effect that each of the configuration settings has on the ultimate resource production. In embodiments, the optimization software 610 may store an indication of a correlation between an adjustment in one or more configuration settings and a resulting change in resource production/timing. Using such information, the optimization software 610 may be further configured to identify a set of configuration settings that, when implemented in the simulated environment, result in a predicted resource production that is optimized with respect to an indicated attribute. In embodiments, each setting in a set of configuration settings may represent a value or configuration to be implemented by a particular control mechanism operating within the resource production process. For example, one setting may indicate a degree to which a particular valve should be opened/closed.

In some cases, once such a set of configuration settings has been determined, the optimization software 610 may be further configured to determine an amount of steam/electricity to be directed to the resource production plant based on the set of configuration settings. For example, based on the configuration settings, the optimization software 610 may determine a quantity/temperature of steam that is needed by each of the individual components operating in the resource production process. In this example, the optimization software 610 may calculate a total amount of steam to be directed to the resource production plant as a sum of the steam requirements for the individual components plus an amount determined to offset loss (e.g., from condensation, cooling, etc.).

An implementation software 612 may be configured to, when executed by the processor 602, cause a set of configuration settings to be implemented by a resource production plant. In some cases, the IES control system 600 is implemented within a resource production plant. In such cases, the IES control system 600 may provide instructions to each of a number of control mechanisms operating in the resource production process to cause them to implement a respective setting associated with that control mechanism (e.g., by activating one or more actuators on the control mechanism to achieve a desired configuration). In other cases, the IES control system 600 is implemented outside of the resource production plant (e.g., either in the power production plant or as a standalone computing device). In such cases, the implementation software 612 may be configured to provide the set of configuration settings to a control unit within the resource production plant in a format that is consumable by that control unit.

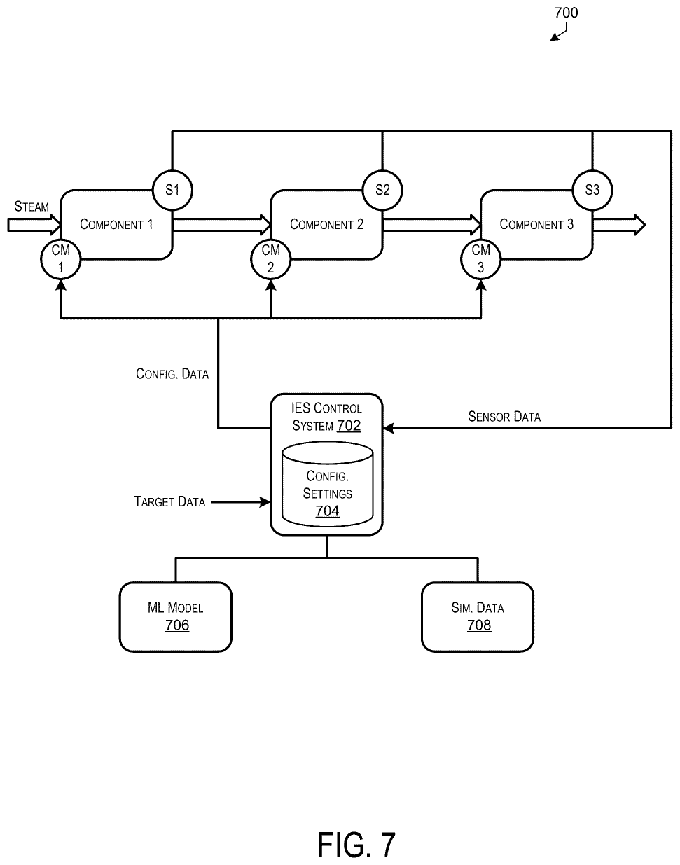

FIG. 7 depicts a block diagram illustrating an architecture for managing a number of resource production process components via an IES control system in accordance with at least some embodiments. It should be noted that while the IES control device of FIG. 7 may provide instructions directly to one or more control mechanisms (e.g., via implementation within a resource production plant) in some embodiments, the IES control system may instead provide a set of configuration settings to another device within the resource production plant in other embodiments.

In the architecture 700, an IES control system 702 is coupled with a number of control mechanisms CM1-CM3. Such control mechanisms CM1-CM3 may each be coupled with, or at least manage input/output for, one or more process components (e.g., component 1-3) operating within a resource production process. As noted elsewhere, a set of such process components 1-3 may be included in one or more resource production units of a resource production plant (e.g., resource production plant 104).

Additionally, the IES control system 702 may be in communication with a number of sensors S1-S3. Each of those sensors may be configured to capture information about the components 1-3 and/or an environment within which the components 1-3 are located. As noted elsewhere, the sensors S1-S3 provide sensor data to the IES control system 702 with which they are in communication.

During operation, the IES control system 702 receives target data from another entity (e.g., an administrative user or another computing device). In some embodiments, the target data may include information about a total amount of a target resource to be produced by the components 1-3 or a rate of resource production to be achieved (e.g., amount per minute). In some embodiments, the target data may include information about an amount of power/steam that should be consumed to produce a resource.

Upon receiving the target data, the IES control system 702 may determine one or more configuration setting values that are representative of settings to be applied to various control mechanisms. The configuration setting values may be determined from a database of configuration settings 704 based on the received target data. More particularly, the configuration setting values may be selected to correspond to production of a particular amount of resources as indicated in the target data. The configuration setting values may be determined for each control mechanism coupled with the process components involved in the resource production process. The IES control system 702 may generate instructions to be provided to each of the control mechanisms to cause the specified configuration setting values to be implemented.

In one example, such setting values may indicate a degree to which a valve (an example of a control mechanism) should be opened/closed in order to achieve an expected flow of input/output for a process component that the respective control mechanism is coupled. In this example, configuration settings provided to the valve by the IES control system 702 may be implemented by activating an actuator within the control mechanism to open or close the valve by the specified amount.

As noted elsewhere, the IES control system 702 may be further configured to receive sensor data from each of the sensors S1-S3. The IES control system 702 may compare one or more metric values determined from such sensor data to expected metric values to determine if the current metric value is within an acceptable range of the expected metric value. Such a determination may involve calculating a difference between the current metric value and the expected metric value in order to determine whether that calculated difference below a threshold percentage/ratio of the expected metric value.

For example, the IES control system 702 may determine a current temperature of an environment inside or outside of a process component. In this example, the determined current temperature is then compared to an expected temperature. A determination is then made as to whether that current temperature is within a suitable range of the expected temperature. In some cases, this may involve determining if the current temperature is within some threshold range (e.g., 10%) of the expected temperature. In other cases, this may involve determining if the current temperature is above or below a threshold expected temperature.

Upon determining that one or more current metric values determined from the sensor data is not within a suitable range of the expected metric value, the IES control system 702 may be configured to make one or more adjustments to a configuration setting value as previously determined. The IES control system 702 may then generate new instructions that cause a respective control mechanism to implement such adjustments. For example, upon determining that a pressure of an environment inside of a process component is unacceptably higher than an expected threshold pressure value, a control mechanism for that process component (or a process component connected to that process component) may be configured to restrict input flow into the process component or alternatively to allow increased output flow out of that process component in order to cause the pressure in that process component to be reduced to a suitable level.

In some cases, the IES control system may be configured to make incremental adjustments. For example, upon determining that a pressure within a process component is unacceptably high, the IES control system may be configured to open a valve to relieve pressure in that component. In this example, the IES control system may open the valve a very small amount, determine a change in pressure based on sensor data, open the valve another small amount, and repeat until the pressure is within a suitable range.

In some embodiments, the IES control system 702 may be in communication with a machine learning model 706 that has been trained to correlate resource production targets with configuration setting values. In some cases, as sensor data is received from the various sensors included in the depicted architecture 700, the machine learning model 706 may adjust its training data to include that information. Accordingly, the machine learning model 706 may be utilized to identify particular configuration setting values to be implemented given particular target data.

In some embodiments, one or more configuration setting values as stored in configuration settings 704 may be generated as simulation data 708. Particularly, simulation software may be implemented in which each of the process components (e.g., components 402-422) of a resource production process (e.g., process 400) are implemented virtually within a virtual environment. In such simulation software, each of the control mechanisms CM1-CM3 may have a virtual counterpart whereas sensor data received from the sensors S1-S3 may be simulated/calculated.

In embodiments, a user operating the simulation software may experiment with different combinations of configuration setting values to be applied to virtual control mechanisms in order to achieve a desired result (e.g., a resource production target). In such cases, the simulation software will attempt to calculate a real-world result at one or more process components from implementation of particular configuration setting values. It should be noted that a configuration setting implemented at a single control mechanism may impact multiple process components. For example, a control mechanism that includes a valve located in a pipe between two process components may act to restrict/allow flow through the pipe. In this example, the pipe may serve as both an output pipe for a first process component and an input pipe for a second process component. Accordingly, opening such a valve may increase a flow within the pipe, resulting in lowering pressure in the first process component and increasing pressure in the second process component.

In embodiments, configuration setting values used in the simulation software may be translated into configuration settings to be implemented in real-world components, (e.g., via control mechanisms CM1-CM3)).

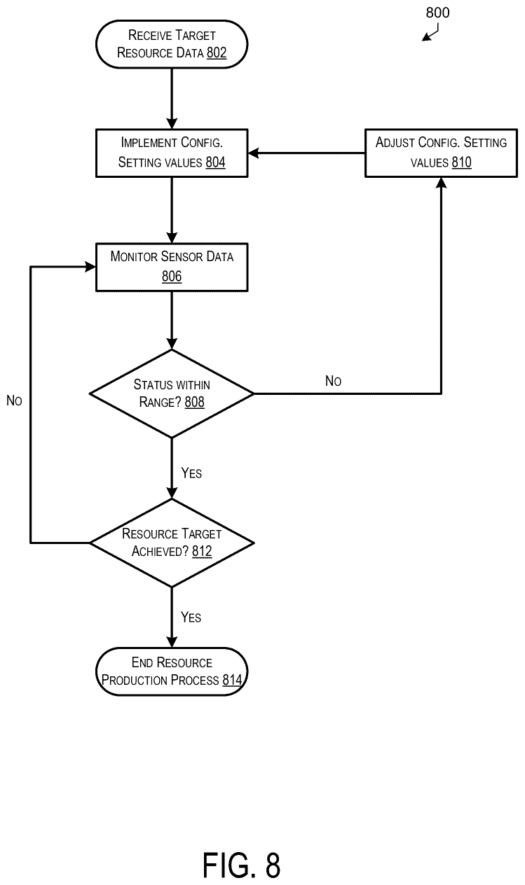

FIG. 8 depicts a flow diagram illustrating a process 800 for managing various process components operating within a resource production process in accordance with some embodiments. In embodiments, the process 800 is performed by an IES control system, such as the IES control system 114 as described in relation to FIG. 1 above. The IES control system 114 may be a component of a control room in a power plant that is configured to operate nuclear reactors and associated instrumentations and controls. Additionally, the IES control system 114 may be in communication with a resource production plant (e.g., resource production plant 104). As noted elsewhere, the resource production plant may include a number of resource production units, each of which include a set of process components that are configured to produce the resource. In embodiments, various process components may be arranged within the resource production unit in a series, such that an output of one process component is provided as an input to another. In these embodiments, each of the process components may perform a refinement/processing step of the resource production process, ultimately resulting in the production of the target resource.

At 802, a process 800 may involve receiving target resource data related to resource production. In some cases, target resource data may include an amount/rate of resource to be produced by the resource production plant. In other cases, the target resource data may include an indication of an excess amount of power/steam being produced by a power plant to be consumed via the resource production process.

In embodiments, the IES control system may determine a maximum amount of resources that can be produced by a single nuclear reactor module implemented within the power plant. In such embodiments, the maximum production amount may be used to determine a number of the nuclear reactor modules that should be spun up or activated to achieve a target resource production amount.

In embodiments, the IES control system may determine an amount of power and/or steam that is consumed by a resource production plant in order to produce a respective resource. In such embodiments, the IES control system may determine a number of the nuclear reactor modules that should be spun up or activated to consume a power excess as indicated within the target resource data.

At 804, the process 800 may involve identifying and implementing a number of configuration setting values. As noted elsewhere, this may involve retrieving information about correlations between a particular process component and a resource to be produced. Such correlations may include a mapping of a quantity/amount of resource that corresponds to various configuration setting values as implemented on respective control mechanisms of the nuclear reactor module. In embodiments, the IES control system may calculate, or retrieve, a configuration setting value for each of the control mechanisms corresponding to the components included in the nuclear reactor module. Additionally, the IES control system may calculate a configuration setting value for one or more control mechanisms in communication with respective resource production components of a resource production plant.

Upon identifying configuration setting values to be applied to a component, the IES control system is configured to generate instructions to be implemented via one or more control mechanisms. For example, the IES control system may generate instructions directed to a control mechanism to cause it to open or close a valve by a determined amount. In some cases, implementing a configuration setting value on a process component may involve adjusting settings of multiple control mechanisms. For example, in order to increase an amount of pressure within a component, the IES control system may generate instructions to control mechanisms that control both input and output for the component. In this example, a first control mechanism may be provided with instructions to open an input valve for the process component by some first determined amount. At the same time, a second control mechanism may be provided with instructions to close an output valve for the process component by some second determined amount. The implementation of such instructions would result in an increase in the pressure within the component.

At 806, the process 800 may involve monitoring sensor data received from sensors coupled with process components of a nuclear reactor module. In embodiments, the IES control system may receive sensor data from a number of sensors positioned throughout the nuclear reactor module. In some embodiments, various sensors may be coupled with process components in order to obtain information about that component or an environment in which the component is located. By way of example, a thermometer sensor may be coupled to a component in order to provide information to the IES control system about a temperature of the materials within that component. In another example, a pressure sensor may be installed within a component to provide information to the IES control system about an amount of atmospheric pressure within the component. It should be noted that any suitable type of sensor may be used to collect respective sensor data that is then reported to the IES control system. Some sensors may collect information about an environment in which the resource production process is being performed or about safety issues related to such resource production. For example, a strain sensor may collect information about a degree of structural distortion (or strain) to one or more process components or structural components.

At 808, the process 800 may involve determining if one or more metrics (as calculated from the received sensor data) is within a suitable range of values. In embodiments, one or more metrics are calculated from the sensor data that is received from the various sensors throughout the nuclear reactor module. For example, sensor data received from a thermometer sensor may be converted into a current temperature metric. Each of the current metric values calculated in this manner may be compared to expected metric values to determine if the current metric values are within a suitable range. In some cases, a suitable range may be determined based on a threshold value. For example, a suitable range may mean that the current metric values are below (and/or above) the threshold value. In another example, a suitable range may mean that the current metric values are within some percentage (e.g., 10%) of the threshold value.

Upon determining that the one or more metrics are not within a suitable range (e.g., “No” from 808), the process 800 may involve making one or more adjustments to the configuration setting values at 810. In some cases, the IES control system is configured to calculate a new configuration setting value that, when implemented, should bring the sensor data within the suitable range. In such cases, the IES control system may be configured to generate new instructions to be executed by the respective control mechanism(s) to achieve the desired range. In other cases, the IES control system is configured to calculate an incremental change in the configuration setting value that, when implemented, will result in the sensor data moving toward the suitable range. In such cases, the IES control system may be configured to generate new instructions to be executed by the respective control mechanism(s) to incrementally update the status of the component. This may be repeated as new sensor data is received until the metric value calculated from the sensor data is within the suitable range.

It should be noted that adjusting configuration setting values (e.g., at 810) may be done on multiple control mechanisms. For example, one skilled in the art would recognize that while closing an output valve for a first component would raise a pressure within that process component, it may also lower pressure in a downstream process component for which that valve is also an input valve. Hence, another adjustment may need to be made to a second control mechanism associated with the downstream process component. Accordingly, an IES control system may be caused to update multiple configuration setting values for the control mechanisms within a nuclear reactor module based on a single current metric value calculated from the received sensor data.

Upon determining that the one or more metrics are within a suitable range (e.g., “Yes” from 808), the process 800 may involve making a determination as to whether the resource production target has been achieved at 812. For example, a determination may be made as to whether an amount of resource has been produced that matches a requested amount. In another example, a determination may be made that a resource storage (e.g., a storage tank) has been filled or is at capacity. In yet another example, a determination may be made as to whether the amount of excess power/steam produced by the power plant is greater than an amount of power/steam consumed by the resource production plant to produce the resource.

Upon determining that the resource production target has not been achieved (e.g., “No” from 812), the process 800 may involve returning to 806 and continuing to monitor sensor data. Upon determining that the resource production target has been achieved (e.g., “Yes” from 812), the process 800 may involve ending the resource production process at 814. In embodiments, this may mean spinning down one or more nuclear reactor module that includes each of a number of components.

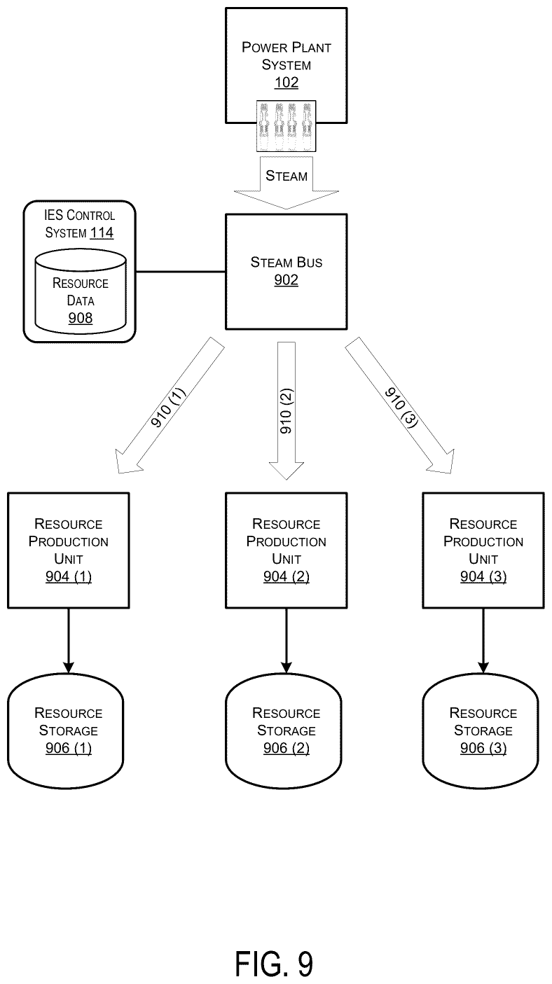

FIG. 9 depicts a block diagram illustrating an exemplary process for allocating steam and power to different resource production processes in accordance with at least some embodiments. As noted elsewhere, power may be produced by a power plant system 102 as described in relation to FIG. 1. As also noted, the power plant, during production of that power, may also produce steam as a byproduct. However, as noted elsewhere, this steam can be used in various resource production processes.

As noted elsewhere, the IES control system 114 may be implemented within the power plant system (e.g., within a control room), within a resource production plant (e.g., as a control device), or as a standalone computing device in communication with both a power plant system and a resource production plant.

An IES control system 114 may be configured to allocate steam received at a steam bus 902 (and power) to one or more resource production modules 904 (1-3). Each of the resource production modules 904 (1-3) may be configured to produce a respective resource which is stored in a respective resource storage 906 (1-3). As noted elsewhere, each of the resource production modules may include a set of process components that are configured to operate in tandem to produce a resource. In some cases, the resource production modules 904 may each produce different types of resources. Hence, the set of process components included in each of the resource production modules 904 may vary based on the particular resource that is produced by that resource production module. Accordingly, an amount of steam and/or power that is consumed by a particular resource production module 904 may vary based on the particular set of process components that it includes as well as one or more current settings (e.g., configuration setting values that are currently applied to various control mechanisms) as applied to the resource production module. It should be noted that a resource production plant (e.g., resource production plant 104) may include resource production modules that produce a single resource or it may include different types of resource production modules configured to produce a variety of resources.

As noted elsewhere, the IES control system may be configured to determine one or more resource production modules 904 to be spun up. In some cases, one or more resource production modules 904 may be spun up to generate a specified amount of a particular resource. In some cases, one or more resource production modules 904 may be spun up to consume some amount of excess power and/or “waste” steam produced by the power plant system 102.

In embodiments, the IES control system may determine one or more resource production modules 904 to be spun up based on information included in resource data 908.

In some cases, the resource data 908 may indicate conditions under which there is a determined need for particular resources. In one example, sensor data may be received from the IES control system 114 that indicates a degree to which a resource storage 906 associated with a particular resource/resource production module 904. Such sensor data may include information about a degree to which the resource storage 906 is currently filled. In one example, this information may be received as pressure data from a pressure sensor. In another example, this information may be received as level data from a liquid level detection sensor. In these embodiments, the IES control system 114 may be configured to prioritize production of resources that are determined to be needed based on a determined stored amount of the resource being low (e.g., below a threshold amount).

In some cases, the resource data 908 may indicate a default resource priority that will be implemented by the IES control system 114. For example, the IES control system 114 may be configured to default to H₂ production unless a resource storage for H₂ is currently full. In this example, the resource data 908 may include an indication of a list of resources produced by the various resource production modules as well as an indicated priority for the respective resource. In such cases, the IES control system 114 may be configured to allocate steam/power to resource production modules 904 that are configured to produce the resource with the highest priority at any point in time. Once a sufficient amount of that resource has been produced (e.g., an amount of the resource included in the resource storage is greater than a threshold amount), the IES control system 114 may be configured to identify the resource with the next highest priority and may subsequently allocate steam/power to one or more resource production modules that are configured to produce that resource.

In operation, upon identifying a resource production module 904 to be spun up, the IES control system 114 may be configured to determine an amount of steam 910 to be consumed by that resource production module. The IES control system 114 may then provide instructions to a steam bus 902, and particularly an actuator implemented within the steam bus, to cause it to provide an amount of steam 910 appropriate for the spun-up resource production module. Note that the amount of steam 910 (1-3) may vary based on requirements of the particular resource production module 904 (1-3) to which it is being allocated. In some cases, the amount of steam consumed by a particular resource production unit may be calculated as a function of the steam consumed by individual components within that resource production unit as well as a predicted loss in volume for the steam (e.g., as a result of condensation). In some cases, a loss in volume may be calculated as a function of the distance between the power plant system providing the steam and the resource production unit.

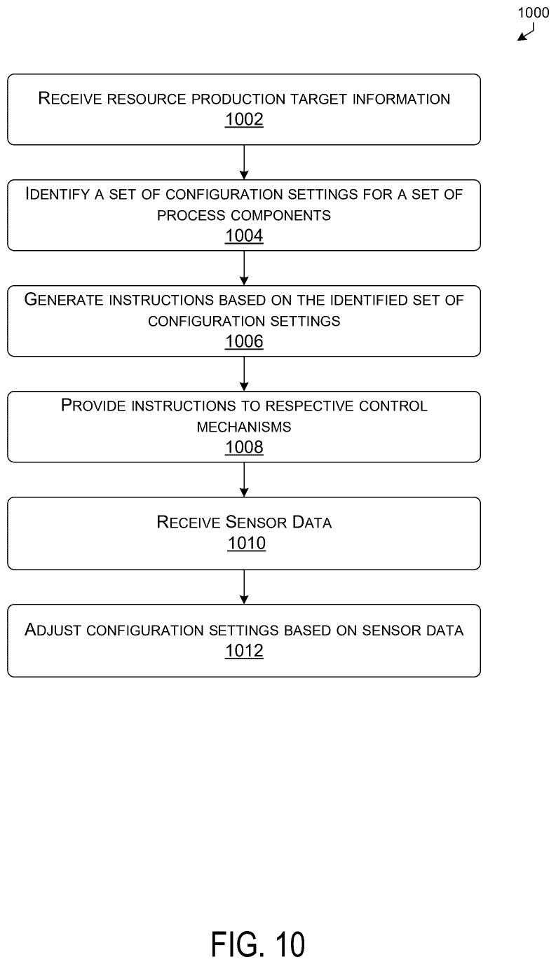

FIG. 10 depicts a flow diagram illustrating a first exemplary process for managing resource production operations in accordance with at least some embodiments. The process 1000 may be performed within a IES by a IES control system, such as the IES control system 114 as described in relation to FIG. 1 above. As noted elsewhere, a IES may include a power plant, a IES control system, and a resource production plant having a set of process components configured to produce a resource, at least one control mechanism, and at least one sensor configured to collect information about the set of process components.

At 1002, a process 1000 may involve receiving information about a resource production target. The information about a resource production target may be received from another computing device either outside of, or included within, the IES. For example, the information about the resource production target may be received from a user device operated by an administrator.

The information about the resource production target may include any suitable information about one or more resources to be produced. In some cases, the resource production target is an indication of an amount of a resource to be produced by the set of process components. In other cases, the resource production target is an indication of a power excess for the power plant. In such cases, the set of process components may be selected to be spun up based on an amount of steam consumed by the set of process components being below an amount of the power excess.

At 1004, the process 1000 may involve identifying a set of configuration setting values for a set of process components based on the information about the resource production target. In some cases, the set of configuration settings associated with the set of process components is generated by simulation software. For example, simulation software may be used to calculate one or more results/statuses for various process components given specified configuration setting values. In some cases, the set of configuration settings associated with the set of process components is generated using one or more machine learning modules.

At 1006, the process 1000 may involve generating instructions based on the identified set of configuration settings. The instructions may be formatted in a manner such that they are executable by the respective control mechanisms. Accordingly, instructions generated for a particular control mechanism may include information in a protocol/language that is used by that control mechanism. Additionally, the instructions may be provided to each control mechanism in a manner such that the control mechanism is capable of receiving it.

At 1008, the process 1000 may involve providing instructions to respective control mechanisms. By way of non-limiting example, such control mechanism may include at least one of a valve, heater, or pump. For example, one or more control mechanism in the set of control mechanisms may be a valve and the generated instructions, in that example, causes an actuator in the one or more control mechanism to adjust a degree to which the valve is opened. In another example, one or more control mechanism in the set of control mechanisms is a heater and the generated instructions causes the heater to heat a material up to a predetermined temperature.

In some embodiments, prior to providing the instructions to the control mechanisms, the IES control system may provide a notification to one or more user device with an indication of the configuration setting values to be implemented. For example, upon determining a set of configuration setting values to be implemented, the IES control system may provide a notification to an administrator (or other suitable user) to obtain approval for implementation of those configuration setting values. In such cases, the IES control system may be configured to not provide the generated instructions to the control mechanisms until it receives approval from the user device to which the notification was sent.

At 1010, the process 1000 may involve receiving sensor data from one or more sensors in communication with the set of process components. The sensors may include any suitable sensor device capable of collecting information about a process component or an environment in which the process component is located. In a nonlimiting example, such a sensor might be at least one of a thermometer or a barometric pressure sensor. In some cases, the IES control system may be configured to determine whether a status of one or more of the process components is optimal (e.g., metric values associated with the process component are within a suitable range) based on the sensor data.

At 1012, the process 1000 may involve adjusting configuration settings based on the received sensor data. In such cases, the IES control system may be further configured to determine a difference between the at least one metric value and an expected metric value, and upon determining that the difference is greater than a threshold value, calculate an adjustment to the set of configuration settings. Accordingly, the IES control system may generate second instructions based on the adjusted set of configuration settings and providing the second instructions to at least one control mechanism in the set of control mechanisms to cause it to implement the adjusted configuration setting value.

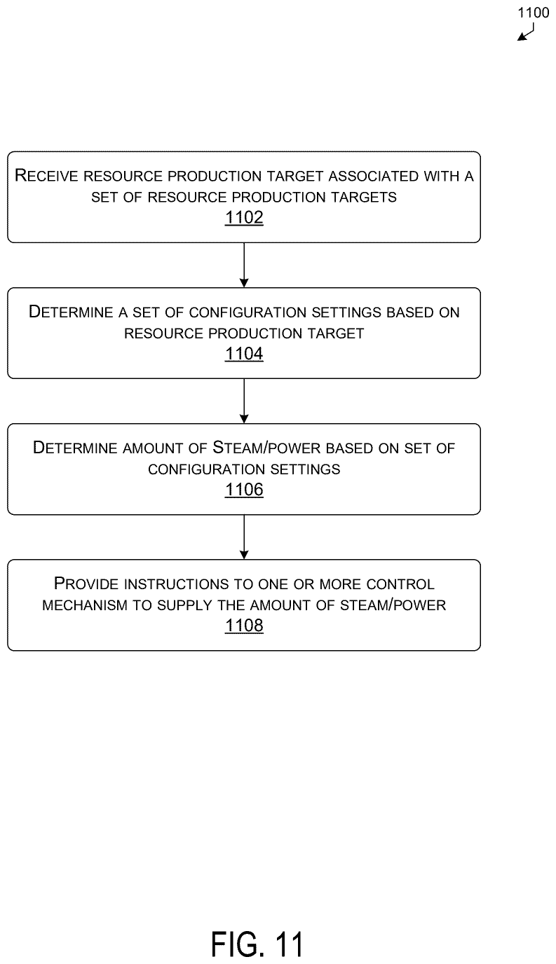

FIG. 11 depicts a flow diagram illustrating a second exemplary process for managing resource production operations in accordance with at least some embodiments. The process 1100 may be performed by a IES control system, such as the IES control system 114 as described in relation to FIG. 1 above. The IES control system may be implemented within an IES that also includes a power plant system and a resource production plant. The power plant system may include a number of PGMs that produce the steam and power. The resource production plant may include a set of resource production components.

At 1102, the process 1100 may involve receiving an indication of a resource production target associated with a set of resource production components. In some cases, the resource production target is received from a user or computing device. In other cases, the resource production target is calculated based on a power excess for a power grid receiving power from the power plant system.

At 1104, the process 1100 may involve determining, based on the resource production target, a set of configuration settings associated with the set of resource production components. In some cases, the set of configuration settings associated with resource production components may be static, in that those configuration settings are not adjusted during a resource production process. In such cases, the steam provided to the resource production process may be converted into a predetermined amount of resource. Accordingly, the amount of steam may be calculated based on a conversion rate associated with the resource production process. In other cases, the set of configuration settings may be determined (e.g., via the process 1000 described in relation to FIG. 10) in order to optimize resource production.

At 1106, the process 1100 may involve determining, based on the set of configuration settings associated with the set of resource production components, an amount of steam and power to achieve the resource production target. In some cases, the amount of steam may be determined as a steam flow rate over a period of time. In other cases, the amount of steam is determined as a total volume of steam needed to produce an amount of resource of the resource production target. In some embodiments, the amount of steam may be determined based at least in part on a temperature of steam needed by the set of resource production components. For example, in order to get the steam to a particular temperature, the steam may need to either be heated or compressed. In the case that the steam is compressed, a larger volume of steam may be required.

The amount of steam may be determined based at least in part on steam requirements for individual resource production components in the set of resource production components. More particularly, the amount of steam may be determined based on a sum of the steam requirements and a predicted loss of steam volume (e.g., loss due to condensation).

At 1108, the process 1100 may involve providing instructions to one or more control mechanisms of a power plant system to cause the power production plant to provide the amount of steam and power to the set of resource production components. In some cases, the one or more control mechanisms may include at least one of a valve or a switch. In such cases, the instructions may cause the one or more control mechanisms to implement an indicated configuration. For example, where a control mechanism is a valve, the instructions may cause the valve to be opened or closed to achieve a predetermined degree of openness.

In some cases, the one or more control mechanisms is included in a steam bus of the power plant system that is configured to distribute steam to entities outside of the power plant system. In such cases, the instructions may cause the steam bus to adjust a flow rate of steam passing through it. In other cases, the one or more control mechanisms manage operations of a PGM in the power plant system. In such cases, the one or more control mechanisms may increase or decrease power production by the PGM, which impacts the amount of steam produced by that PGM. In some cases, the instructions may cause one or more of the PGMs to be spun up or spun down.

As noted elsewhere, the process 1100 may further involve providing the set of configuration settings to a resource production plant that includes the set of resource production components. In such cases, the set of configuration settings may be implemented by the resource production plant by providing instructions to individual control mechanisms within it.

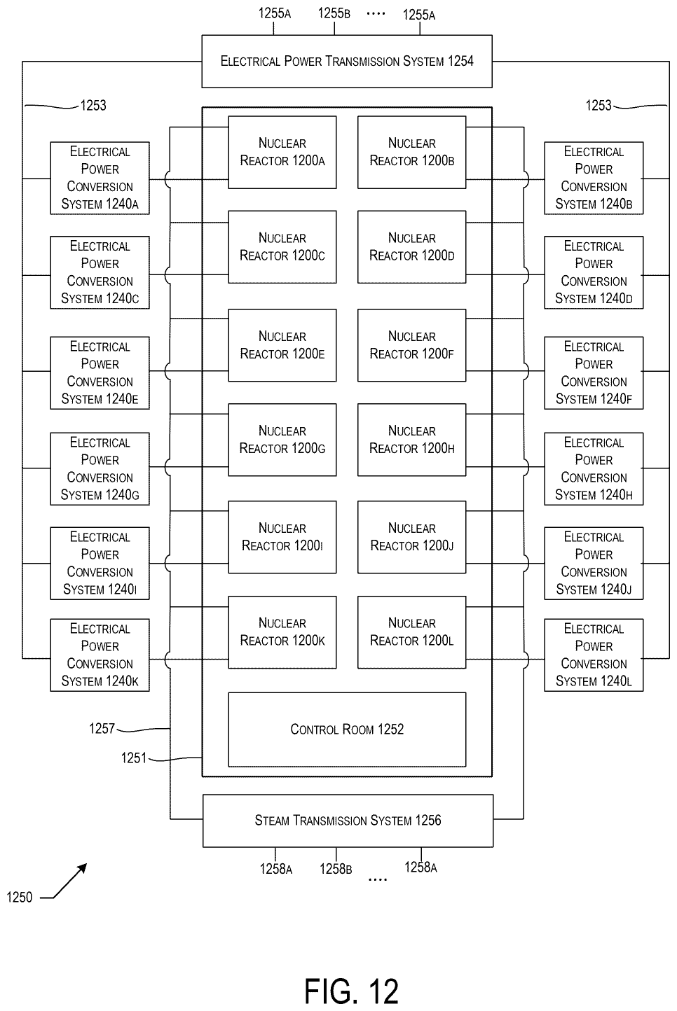

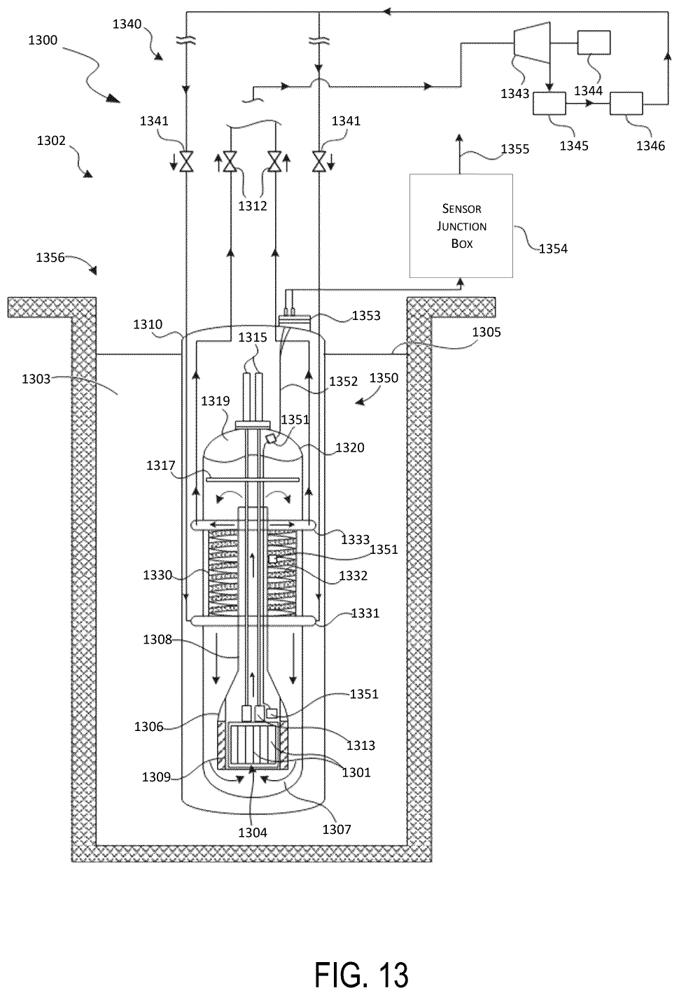

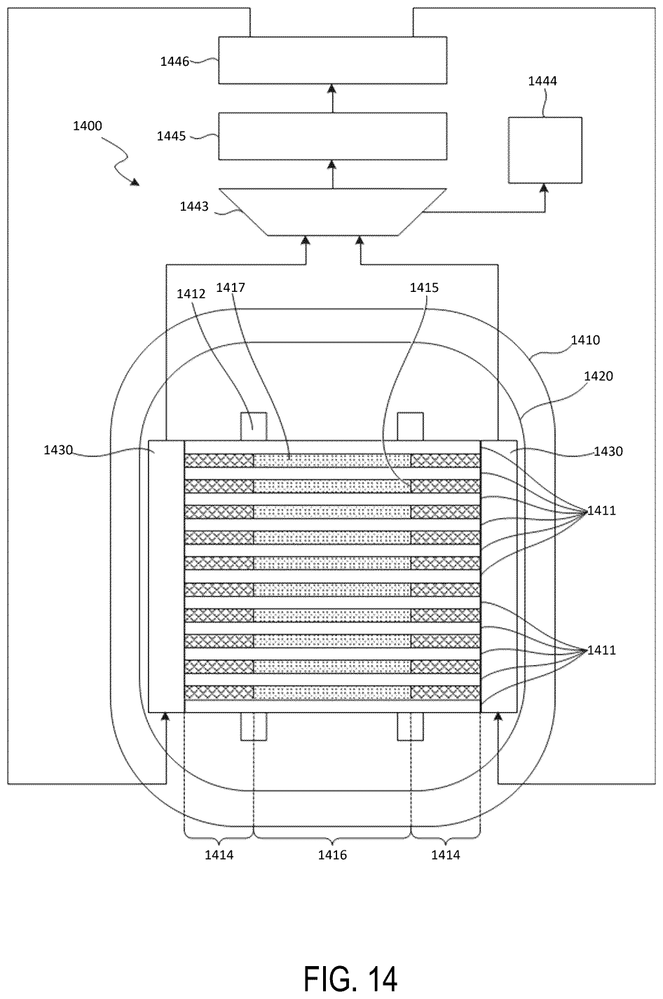

FIG. 12 is a schematic view of a nuclear power plant system 1250 (“power plant system 1250”) including multiple nuclear reactors 1200 (individually identified as first through twelfth nuclear reactors 1200a-1, respectively) in accordance with embodiments of the present technology. Each of the nuclear reactors 1200 can be similar to or identical to the nuclear reactor system 1300 and/or the nuclear reactor 1400 described in detail below with reference to FIGS. 13 and 14. The power plant system 1250 can be “modular” in that each of the nuclear reactors 1200 can be operated separately to provide an output, such as electricity or steam. The power plant system 1250 can include fewer than twelve of the nuclear reactors 1200 (e.g., two, three, four, five, six, seven, eight, nine, ten, or eleven of the nuclear reactors 1200), or more than twelve of the nuclear reactors 1200. The power plant system 1250 can be a permanent installation or can be mobile (e.g., mounted on a truck, tractor, mobile platform, and/or the like). In the illustrated embodiment, each of the nuclear reactors 1200 can be positioned within a common housing 1251, such as a reactor plant building, and controlled and/or monitored via a control room 1252.

Each of the nuclear reactors 1200 can be coupled to a corresponding electrical power conversion system 1240 (individually identified as first through twelfth electrical power conversion systems 1240a-1, respectively). The electrical power conversion systems 1240 can include one or more devices that generate electrical power or some other form of usable power from steam generated by the nuclear reactors 1200. For example, the electrical power conversion systems 1240 can include features that are similar or identical to the power conversion system 1340 described in detail below with reference to FIG. 13. In some embodiments, multiple ones of the nuclear reactors 1200 can be coupled to the same one of the electrical power conversion systems 1240 and/or one or more of the nuclear reactors 1200 can be coupled to multiple ones of the electrical power conversion systems 1240 such that there is not a one-to-one correspondence between the nuclear reactors 1200 and the electrical power conversion systems 1240.

The electrical power conversion systems 1240 can be further coupled to an electrical power transmission system 1254 via, for example, an electrical power bus 1253. The electrical power transmission system 1254 and/or the electrical power bus 1253 can include one or more transmission lines, transformers, and/or the like for regulating the current, voltage, and/or other characteristic(s) of the electricity generated by the electrical power conversion systems 1240. The electrical power transmission system 1254 can route electricity via a plurality of electrical output paths 1255 (individually identified as electrical output paths 1255a-n) to one or more end users and/or end uses, such as different electrical loads of an integrated energy system as described in greater detail below.

The power plant system 1250 can be configured in a first operating state to provide electricity to the water treatment plant 106 (e.g., via one or more of the electrical output paths 1255 from the electrical power transmission system 1254). The water treatment plant 106 can route the produced high-quality water to the power plant system 1250, and the power plant system 1250 can use the water to produce high-quality steam. For example, the produced water can be used as a secondary coolant in a steam generator of one or more of the nuclear reactors 1200. In some embodiments, the water treatment plant 106 can be omitted and the power plant system 1250 can utilize water from other sources to generate steam.

Each of the nuclear reactors 1200 can further be coupled to a steam transmission system 1256 via, for example, a steam bus 1157. The steam bus 1157 can route steam generated from the nuclear reactors 1200 to the steam transmission system 1256 which in turn can route the steam via a plurality of steam output paths 1158 (individually identified as steam output paths 1158a-n) to one or more end users and/or end uses, such as different steam inputs of an integrated energy system as described in greater detail below.

In some embodiments, the nuclear reactors 1200 can be individually controlled (e.g., via the control room 1252) to provide steam to the steam transmission system 1256 and/or steam to the corresponding one of the electrical power conversion systems 1240 to provide electricity to the electrical power transmission system 1254. In some embodiments, the nuclear reactors 1200 are configured to provide steam either to the steam bus 1157 or to the corresponding one of the electrical power conversion systems 1240, and can be rapidly and efficiently switched between providing steam to either. Accordingly, in some aspects of the present technology the nuclear reactors 1200 can be modularly and flexibly controlled such that the power plant system 1250 can provide differing levels/amounts of electricity via the electrical power transmission system 1254 and/or steam via the steam transmission system 1256. For example, where the power plant system 1250 is used to provide electricity and steam to one or more industrial process—such as various components of the integrated energy systems described in the detail below—the nuclear reactors 1200 can be controlled to meet the differing electricity and steam requirements of the industrial processes.

As one example, during a first operational state of an integrated energy system employing the power plant system 1250, a first subset of the nuclear reactors 1200 (e.g., the first through sixth nuclear reactors 1200a-f) can be configured to provide steam to the steam transmission system 1256 for use in the first operational state of the integrated energy system, while a second subset of the nuclear reactors 1200 (e.g., the seventh through twelfth nuclear reactors 1200g-1) can be configured to provide steam to the corresponding ones of the electrical power conversion systems 1240 (e.g., the seventh through twelfth electrical power conversion systems 1240g-1) to generate electricity for the first operational state of the integrated energy system. Then, during a second operational state of the integrated energy system when a different (e.g., greater or lesser) amount of steam and/or electricity is required, some or all the first subset of the nuclear reactors 1200 can be switched to provide steam to the corresponding ones of the electrical power conversion systems 1240 (e.g., the seventh through twelfth electrical power conversion systems 1240g-1) and/or some or all of the second subset of the nuclear reactors 1200 can be switched to provide steam to the steam transmission system 1256 to vary the amount of steam and electricity produced to match the requirements/demands of the second operational state. Other variations of steam and electricity generation are possible based on the needs of the integrated energy system. That is, the nuclear reactors 1200 can be dynamically/flexibly controlled during other operational states of an integrated energy system to meet the steam and electricity requirements of the operational state.

In contrast, some conventional nuclear power plant systems can typically generate either steam or electricity for output, and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 1200 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini-computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

FIGS. 13 and 14 illustrate representative nuclear reactors that may be included in embodiments of the present technology. FIG. 13 is a partially schematic, partially cross-sectional view of a nuclear reactor system 1300 configured in accordance with embodiments of the present technology. The nuclear reactor system 1300 can include a power module 1302 having a reactor core 1304 in which a controlled nuclear reaction takes place. Accordingly, the reactor core 1304 can include one or more fuel assemblies 1301. The fuel assemblies 1301 can include fissile and/or other suitable materials. Heat from the reaction generates steam at a steam generator 1330, which directs the steam to a power conversion system 1340. The power conversion system 1340 generates electrical power, and/or provides other useful outputs, such as super-heated steam. A sensor system 1350 is used to monitor the operation of the power module 1302 and/or other system components. The data obtained from the sensor system 1350 can be used in real time to control the power module 1302, and/or can be used to update the design of the power module 1302 and/or other system components.

The power module 1302 includes a containment vessel 1310 (e.g., a radiation shield vessel, or a radiation shield container) that houses/encloses a reactor vessel 1320 (e.g., a reactor pressure vessel, or a reactor pressure container), which in turn houses the reactor core 1304. The containment vessel 1310 can be housed in a power module bay 1356. The power module bay 1356 can contain a cooling pool 1303 filled with water and/or another suitable cooling liquid. The bulk of the power module 1302 can be positioned below a surface 1305 of the cooling pool 1303. Accordingly, the cooling pool 1303 can operate as a thermal sink, for example, in the event of a system malfunction.

A volume between the reactor vessel 1320 and the containment vessel 1310 can be partially or completely evacuated to reduce heat transfer from the reactor vessel 1320 to the surrounding environment (e.g., to the cooling pool 1303). However, in other embodiments the volume between the reactor vessel 1320 and the containment vessel 1310 can be at least partially filled with a gas and/or a liquid that increases heat transfer between the reactor vessel 1320 and the containment vessel 1310. For example, the volume between the reactor vessel 1320 and the containment vessel 1310 can be at least partially filled (e.g., flooded with the primary coolant 1307) during an emergency operation.

Within the reactor vessel 1320, a primary coolant 1307 conveys heat from the reactor core 1304 to the steam generator 1330. For example, as illustrated by arrows located within the reactor vessel 1320, the primary coolant 1307 is heated at the reactor core 1304 toward the bottom of the reactor vessel 1320. The heated primary coolant 1307 (e.g., water with or without additives) rises from the reactor core 1304 through a core shroud 1206 and to a riser tube 1308. The hot, buoyant primary coolant 1307 continues to rise through the riser tube 1308, then exits the riser tube 1308 and passes downwardly through the steam generator 1330. The steam generator 1330 includes a multitude of conduits 1332 that are arranged circumferentially around the riser tube 1308, for example, in a helical pattern, as is shown schematically in FIG. 13. The descending primary coolant 1307 transfers heat to a secondary coolant (e.g., water) within the conduits 1332, and descends to the bottom of the reactor vessel 1320 where the cycle begins again. The cycle can be driven by the changes in the buoyancy of the primary coolant 1307, thus reducing or eliminating the need for pumps to move the primary coolant 1307.

The steam generator 1330 can include a feedwater header 1331 at which the incoming secondary coolant enters the steam generator conduits 1332. The secondary coolant rises through the conduits 1332, converts to vapor (e.g., steam), and is collected at a steam header 1333. The steam exits the steam header 1333 and is directed to the power conversion system 1340.

The power conversion system 1340 can include one or more steam valves 1342 that regulate the passage of high pressure, high temperature steam from the steam generator 1330 through steam valve 131312 to a steam turbine 1343. The steam turbine 1343 converts the thermal energy of the steam to electricity via a generator 1344. The low-pressure steam exiting the turbine 1343 is condensed at a condenser 1245, and then directed (e.g., via a pump 1246) to one or more feedwater valves 1241. The feedwater valves 1241 control the rate at which the feedwater re-enters the steam generator 1330 via the feedwater header 1331. In other embodiments, the steam from the steam generator 1330 can be routed for direct use in an industrial process, such as a hydrogen and oxygen production plant, a chemical production plant, and/or the like, as described in detail in this application. Accordingly, steam exiting the steam generator 1330 can bypass the power conversion system 1340.

The power module 1302 includes multiple control systems and associated sensors. For example, the power module 1302 can include a hollow cylindrical reflector 1309 that directs neutrons back into the reactor core 1304 to further the nuclear reaction taking place therein. Control rods 1313 are used to modulate the nuclear reaction, and are driven via fuel rod drivers 1315. The pressure within the reactor vessel 1320 can be controlled via a pressurizer plate 1317 (which can also serve to direct the primary coolant 1307 downwardly through the steam generator 1330) by controlling the pressure in a pressurizing volume 1319 positioned above the pressurizer plate 1317.

The sensor system 1350 can include one or more sensors 1351 positioned at a variety of locations within the power module 1302 and/or elsewhere, for example, to identify operating parameter values and/or changes in parameter values. The data collected by the sensor system 1350 can then be used to control the operation of the nuclear reactor system 1300, and/or to generate design changes for the nuclear reactor nuclear reactor system 1300. For sensors positioned within the containment vessel 1310, a sensor link 1352 directs data from the sensors to a flange 1353 (at which the sensor link 1352 exits the containment vessel 1310) and directs data to a sensor junction box 1354. From there, the sensor data can be routed to one or more controllers and/or other data systems via a data bus 1355.

FIG. 14 is a partially schematic, partially cross-sectional view of a nuclear reactor system 1400 (“system 1400”) configured in accordance with additional embodiments of the present technology. In some embodiments, the system 1400 can include some features that are at least generally similar in structure and function, or identical in structure and function, to the corresponding features of the nuclear reactor system 1300 described in detail above with reference to FIG. 13, and can operate in a generally similar or identical manner to the nuclear reactor system 1300.

In the illustrated embodiment, the system 1400 includes a reactor vessel 1420 and a containment vessel 1410 surrounding/enclosing the reactor vessel 1420. In some embodiments, the reactor vessel 1420 and the containment vessel 1410 can be roughly cylinder-shaped or capsule-shaped. The system 1400 further includes a plurality of heat pipe layers 1411 within the reactor vessel 1420. In the illustrated embodiment, the heat pipe layers 1411 are spaced apart from and stacked over one another. In some embodiments, the heat pipe layers 1411 can be mounted/secured to a common frame 1412, a portion of the reactor vessel 1420 (e.g., a wall thereof), and/or other suitable structures within the reactor vessel 1420. In other embodiments, the heat pipe layers 1411 can be directly stacked on top of one another such that each of the heat pipe layers 1411 supports and/or is supported by one or more of the other ones of the heat pipe layers 1411.

In the illustrated embodiment, the system 1400 further includes a shield or reflector region 1414 at least partially surrounding a core region 1416. The heat pipes layers 1411 can be circular, rectilinear, polygonal, and/or can have other shapes, such that the core region 1416 has a corresponding three-dimensional shape (e.g., cylindrical, spherical). In some embodiments, the core region 1416 is separated from the reflector region 1414 by a core barrier 1415, such as a metal wall. The core region 1416 can include one or more fuel sources, such as fissile material, for heating the heat pipes layers 1411. The reflector region 1414 can include one or more materials configured to contain/reflect products generated by burning the fuel in the core region 1416 during operation of the system 1400. For example, the reflector region 1414 can include a liquid or solid material configured to reflect neutrons and/or other fission products radially inward toward the core region 1416. In some embodiments, the reflector region 1414 can entirely surround the core region 1416. In other embodiments, the reflector region 1414 may partially surround the core region 1416. In some embodiments, the core region 1416 can include a control material 1417, such as a moderator and/or coolant. The control material 1417 can at least partially surround the heat pipe layers 1411 in the core region 1416 and can transfer heat therebetween.

In the illustrated embodiment, the system 1400 further includes at least one heat exchanger 1430 (e.g., a steam generator) positioned around the heat pipe layers 1411. The heat pipe layers 1411 can extend from the core region 1416 and at least partially into the reflector region 1414, and are thermally coupled to the heat exchanger 1430. In some embodiments, the heat exchanger 1430 can be positioned outside of or partially within the reflector region 1414. The heat pipe layers 1411 provide a heat transfer path from the core region 1416 to the heat exchanger 1430. For example, the heat pipe layers 1411 can each include an array of heat pipes that provide a heat transfer path from the core region 1416 to the heat exchanger 1430. When the system 1400 operates, the fuel in the core region 1416 can heat and vaporize a fluid within the heat pipes in the heat pipe layers 1411, and the fluid can carry the heat to the heat exchanger 1430. The heat pipes in the heat pipe layers 1411 can then return the fluid toward the core region 1416 via wicking, gravity, and/or other means to be heated and vaporized once again.

In some embodiments, the heat exchanger 1430 can be similar to the steam generator 1330 of FIG. 13 and, for example, can include one or more helically-coiled tubes that wrap around the heat pipe layers 1411. The tubes of the heat exchanger 1430 can include or carry a working fluid (e.g., a coolant such as water or another fluid) that carries the heat from the heat pipe layers 1411 out of the reactor vessel 1420 and the containment vessel 1410 for use in generating electricity, steam, and/or the like. For example, in the illustrated embodiment the heat exchanger 1430 is operably coupled to a turbine 1443, a generator 1444, a condenser 1445, and a pump 1446. As the working fluid within the heat exchanger 1430 increases in temperature, the working fluid may begin to boil and vaporize. The vaporized working fluid (e.g., steam) may be used to drive the turbine 1443 to convert the thermal potential energy of the working fluid into electrical energy via the generator 1444. The condenser 1445 can condense the working fluid after it passes through the turbine 1443, and the pump 1446 can direct the working fluid back to the heat exchanger 1430 where it can begin another thermal cycle. In other embodiments, steam from the heat exchanger 1430 can be routed for direct use in an industrial process, such as a resource production plant, described in detail above. Accordingly, steam exiting the heat exchanger 1430 can bypass the turbine 1443, the generator 1444, the condenser 1445, the pump 1446, etc.

### CONCLUSION

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. An Integrated Energy System (IES) control system comprising:
one or more processors; and
one or more computer-readable media storing instructions that, when executed by the one or more processors, cause the IES control system to perform operations comprising:
receiving an indication of a resource production target associated with a set of resource production components;
determining, based on the resource production target, a set of configuration settings associated with the set of resource production components;
determining, based on the set of configuration settings associated with the set of resource production components, an amount of steam and power to achieve the resource production target; and
providing instructions to one or more control mechanisms of a power plant system to cause the power production plant to provide the amount of steam and power to the set of resource production components.

2. The IES control system of claim 1, wherein the one or more control mechanisms is associated with a steam bus of the power plant system.

3. The IES control system of claim 1, wherein the one or more control mechanisms comprise at least one of a valve or a switch.

4. The IES control system of claim 1, wherein the instructions cause the one or more control mechanisms to implement an indicated configuration.

5. The IES control system of claim 1, wherein the amount of steam is determined as a steam flow rate over a period of time.

6. The IES control system of claim 1, wherein the amount of steam is determined as a total volume of steam.

7. The IES control system of claim 1, wherein the amount of steam is determined based at least in part on a temperature of steam needed by the set of resource production components.

8. The IES control system of claim 1, wherein the operations further comprise providing the set of configuration settings to a resource production plant that includes the set of resource production components.

9. A method comprising:
receiving, by an Integrated Energy System (IES) control system, an indication of a resource production target associated with a set of resource production components;
determining, by the IES control system based on the resource production target, a set of configuration settings associated with the set of resource production components;
determining, by the IES control system based on the set of configuration settings associated with the set of resource production components, an amount of steam and power to achieve the resource production target; and
providing, by the IES control system, instructions to one or more control mechanisms of a power plant system to cause the power production plant to provide the amount of steam and power to the set of resource production components.

10. The method of claim 9, wherein the amount of steam is determined based at least in part on steam requirements for individual resource production components in the set of resource production components.

11. The method of claim 10, wherein the amount of steam is determined based on a sum of the steam requirements and a predicted loss of steam volume.

12. The method of claim 9, further comprising:
determining a target temperature of the amount of steam based on the set of configuration settings; and
providing second instructions to the one or more control mechanisms of the power plant system to cause the amount of steam to be heated to the target temperature.

13. The method of claim 12, wherein the amount of steam is determined based at least in part on the target temperature.

14. The method of claim 12, wherein the amount of steam to be heated to the target temperature using at least one of heating or compression.

15. The method of claim 9, wherein the instructions to one or more control mechanisms cause at least one power generation module (PGM) to increase or decrease power production.

16. The method of claim 9, wherein the one or more control mechanisms are included in a steam bus of the power plant and the instructions cause the steam bus to adjust a flow rate of steam passing through the steam bus.

17. An Integrated Energy System (IES) comprising:
a power plant system that produces steam and power;
a resource production plant comprising a set of process components configured to produce a resource; and
a IES control system configured to:
receive a resource production target associated with the resource production plant;
determine, based on the resource production target, a set of configuration settings for the resource production plant;
determine, based on the set of configuration settings and amount of steam and power to be provided to the resource production plant by the power plant system; and
provide instructions to one or more control mechanisms of the power plant to generate the amount of steam and power.

18. The IES of claim 17, wherein the power plant system comprises a number of power generation modules (PGMs) that produce the steam and power.

19. The IES of claim 18, wherein the instructions cause one or more of the PGMs to be spun up or spun down.

20. The IES of claim 17, wherein the resource production target is based on a power excess for a power grid receiving power from the power plant system.
